(19) United States
(12) Patent Application Publication
(10) Pub. No.: US 2012/0135251 A1
(43) Pub. Date: May 31, 2012

(54) PHOTOSENSITIVE POLYIMIDE HAVING SILICON MODIFIED GROUP, ADHESIVE COMPOSITION AND SEMICONDUCTOR PACKAGE INCLUDING THE SAME

(75) Inventors: Chul Ho JEONG, Gwangju (KR); Joon Yong PARK, Suwon-si (KR); Jae Jun LEE, Suwon-si (KR); Yong Seok HAN, Anyang-si (KR); Mi Jeong SONG, Suwon-si (KR)

(73) Assignee: SAMSUNG ELECTRONICS CO., LTD., Suwon-si (KR)

(21) Appl. No.: 13/165,292

(22) Filed: Jun. 21, 2011

(30) Foreign Application Priority Data
Nov. 26, 2010 (KR) 10-2010-0119206

(51) Int. Cl. B32B 7/12; C09J 179/08; B32B 15/088; C08G 73/10

(52) U.S. Cl. 428/448; 525/431; 524/588; 522/148; 428/473.5

(57) ABSTRACT

A photosensitive polyimide and an adhesive composition and adhesive film containing the same are provided. The photosensitive polyimide has an imide backbone and grafted side chains including a methacrylate-based side chain and a silicon-modified side chain.

### CROSS-REFERENCE TO RELATED APPLICATION

This application claims priority to Korean Patent Application No. 10-2010-0119206, filed on Nov. 26, 2010, and all the benefits accruing therefrom under 35 U.S.C. §119, the content of which in its entirety is herein incorporated by reference.

### BACKGROUND

1. Field

The disclosure relates to a photosensitive polyimide having silicon-modified group, an adhesive composition including the same, a semiconductor package using the adhesive composition, and a method of manufacturing the semiconductor package.

2. Description of the Related Art

In recent years, various semiconductor packages for highly integrated, high capacity semiconductor devices have been developed. In semiconductor packaging, an adhesive film may be used to adhere a semiconductor device to a support substrate.

Such adhesive films have a high degree of thickness control capability and protrusion control, when compared with a conventional paste adhesive. Accordingly, adhesive film is widely used in high-density semiconductor packaging, such as for a chip-size package, a stack package, and a system-in-package.

To mount a semiconductor device in a semiconductor package using an adhesive film, the adhesive film is required to have not only adhesive strength but also thermal resistance, dimensional stability, a wet-proof (non-wetting) property, and low-temperature adhesion.

### SUMMARY

A photosensitive polyimide having high thermal resistance and thermal stability, and good patternability is disclosed.

In an aspect, a photosensitive polyimide includes an aromatic polyimide backbone, a first side chain including a (meth)acryloyl group grafted to the backbone, and a second side chain including the silicon-modified group grafted to the backbone.

In another aspect, an adhesive composition includes the photosensitive polyimide.

In another aspect, an adhesive film is prepared by applying the adhesive composition onto a base material and then removing a solvent.

In another aspect, a semiconductor package includes a plurality of semiconductor chips, and an adhesive layer prepared by curing the above adhesive composition or adhesive film.

In another aspect, a method of manufacturing the semiconductor package includes: applying the adhesive composition or disposing the adhesive film on one surface of a semiconductor chip or substrate; forming a predetermined pattern by exposure and development; and then thermally curing the pattern to form an adhesive layer.

### BRIEF DESCRIPTION OF THE DRAWINGS

The above and other advantages and features of this invention will become more apparent by describing in further detail exemplary embodiments thereof with reference to the accompanying drawings, in which:

FIGS. 1A and 1B are scanning electron microscope (SEM) images of contact holes at A) 45 micrometer pitch, and B) 80 micrometer pitch for Comparative Example 1, which is taken according to Experimental Example 1;

FIGS. 2A and 2B are SEM images of contact holes at A) 45 micrometer pitch, and B) 80 micrometer pitch for Example 1, which is taken according to Experimental Example 1;

FIGS. 3A and 3B are SEM images of contact holes at A) 45 micrometer pitch, and B) 80 micrometer pitch for Example 2, which is taken according to Experimental Example 1.

FIGS. 4A and 4B are SEM images of contact holes at A) 45 micrometer pitch, and B) 80 micrometer pitch for Example 3, which is taken according to Experimental Example 1.

FIGS. 5A and 5B are SEM images of contact holes at A) 45 micrometer pitch, and B) 80 micrometer pitch for Example 4, which is taken according to Experimental Example 1.

FIGS. 6A and 6B are SEM images of contact holes at A) 45 micrometer pitch, and B) 80 micrometer pitch for Example 5, which is taken according to Experimental Example 1.

FIGS. 7A and 7B are SEM images of contact holes at A) 45 micrometer pitch, and B) 80 micrometer pitch for Example 6, which is taken according to Experimental Example 1.

FIGS. 8A and 8B are SEM images of contact holes at A) 45 micrometer pitch, and B) 80 micrometer pitch for Example 7, which is taken according to Experimental Example 1.

FIGS. 9A and 9B are SEM images of contact holes at A) 45 micrometer pitch, and B) 80 micrometer pitch for Example 8, which is taken according to Experimental Example 1.

### DETAILED DESCRIPTION

The invention now will be described more fully hereinafter with reference to the accompanying drawings, in which a non-limiting embodiment is shown. This invention may, however, be embodied in many different forms, and should not be construed as limited to the example embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed steps.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Furthermore, relative terms, such as “lower” or “bottom” and “upper,” may be used herein to describe one element's relationship to another element as illustrated in the figures. It will be understood that relative terms are intended to encompass different orientations of any device described herein. For example, if the device as described is turned over, elements described as being on the “lower” side of other elements would then be oriented on “upper” sides of the other elements. The term “lower,” can therefore, encompasses both an orientation of “lower” and “upper.”. Similarly, if the device is turned over, elements described as “below” other elements would then be oriented “above” the other elements. The terms “below” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

As used herein, “alkyl” refers to a straight or branched chain saturated aliphatic hydrocarbon having the specified number of carbon atoms. “Alkenyl” is a straight or branched chain hydrocarbon that comprises at least one carbon-carbon double bond. Similarly, “cycloalkyl” and “cycloalkenyl” refers to groups including a monovalent cyclic alkyl and monovalent cyclic alkenyl moiety, respectively. “Alkoxy” refers to an alkyl moiety that is linked via an oxygen (i.e., —O-alkyl). Non-limiting examples of C1 to C30 alkoxy groups include methoxy groups, ethoxy groups, propoxy groups, isobutyloxy groups, sec-butyloxy groups, pentyloxy groups, iso-amyloxy groups, hexyloxy groups, octyloxy groups, and the like. The term “alkylene” refers to a straight, branched or cyclic divalent aliphatic hydrocarbon group. The term “alkenylene” refers to a straight, branched or cyclic divalent aliphatic hydrocarbon group containing a double bond. Similarly, “cycloalkylene” and “cycloalkenylene” refers to groups including a divalent cyclic alkyl and divalent cyclic alkenyl moiety, respectively.

As used herein “aryl,” means a cyclic moiety in which all ring members are carbon and at least one ring is aromatic. More than one ring may be present, and any additional rings may be independently aromatic, saturated or partially unsaturated, and may be fused, pendant, spirocyclic or a combination thereof. Optionally, an aryl group may include heteroatoms such as O, N, S, or the like included in the aromatic ring structure. As used herein, the term “arylene” refers to a divalent radical formed by the removal of two hydrogen atoms from one or more rings of an aromatic hydrocarbon, wherein the hydrogen atoms may be removed from the same or different rings (preferably different rings), each of which rings may be aromatic or nonaromatic. As used herein, “aralkyl” refers to an alkylene group in which one of the hydrogen atoms of the alkyl is replaced by an aryl group. Representative aralkyl groups include, for example, a benzyl group, a phenylethyl group, a diphenylenemethylene group, a dimethylenephenylene group, and the like. An “aralkylene” group is an aryl or arylene group linked via an alkyl or alkylene moiety. The specified number of carbon atoms (e.g., C7 to C30) refers to the total number of carbon atoms present in both the aryl and the alkylene moieties. “Aryloxy” refers to an aryl moiety that is linked via an oxygen (i.e., —O-aryl). As used herein, “combination” is inclusive of blends, mixtures, alloys, reaction products, and the like.

As used herein, when a definition is not otherwise provided, the term “substituted” refers to one substituted with a substituent selected from a C1 to C30 alkyl group, a C2 to C30 alkenyl group, a C6 to C30 aryl group, a C7 to C30 aralkyl group, a C1 to C4 oxyalkyl group, a C3 to C30 alicyclic group, a C3 to C15 cycloalkenyl group, a C2 to C30 heterocycloalkyl group, a halogen (F, Cl, Br, or I), a hydroxyl group, a C1 to C30 alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid or a salt thereof, phosphoric acid or a salt thereof, or a combination comprising at least one of the foregoing. Where “fluoro” is used to describe a group such as in “fluoroalkyl”, “fluoroaryl”, etc. it will be understood that the group contains at least one fluorine group, or may be completely fluorinated (i.e., perfluorinated).

1. Photosensitive Polyimide

Photosensitive polyimide having a silicon-modified group according to an exemplary embodiment is composed of an aromatic polyimide backbone onto which a first side chain including a (meth)acryloyl group and a second side chain including the silicon-modified group are grafted. As used herein, “(meth)acryloyl” or “(meth)acrylate” means both “methacryloyl” and “acryloyl,” or “methacrylate” and “acrylate,” respectively.

The photosensitive polyimide, in which a photo-curable (meth)acryloyl group and a silicon-modified group providing thermal resistance are grafted onto the polyimide backbone, may improve patternability during pattern formation by exposure using a light source and development of the pattern using a developer. The photosensitive polyimide may have various physical properties based on the reactivity of the graft, and hence, the photosensitive polyimide may be used in a variety of different applications. In addition, an adhesive composition and adhesive film with higher thermal stability may be prepared from the photosensitive polyimide which may have improved thermal resistance.

The photosensitive polyimide having the silicon-modified group includes a rigid aromatic imide as a main-chain backbone moiety, to improve patternability and to impart desirable properties including high thermal resistance, low coefficient of thermal expansion (CTE), high thermal oxidation resistance, radiation resistance, low-temperature characteristics, and high chemical resistance.

In the photosensitive polyimide having the silicon-modified group, acrylate or methacrylate derivatives are grafted to the polyimide, so that a radical reaction may be carried out, such as photo-initiated crosslinking. Accordingly, the photosensitive polyimide may have higher photosensitivity and enable crosslinking, thus may improve adhesive strength. Also, a (meth)acrylate side chain may be improve solubility. In addition, the photosensitive polyimide contains a silicon-modified side-chain group, which may be converted into a silicon oxide (and in particular, a silicon oxide covalently connected by a carbon atom to the polyimide backbone) by hydrolysis in the presence of other such silicon-modified side-chain group or other silicon oxide precursor molecules such as tetraethylorthosilane (TEOS), methyltrimethoxysilane, or the like, thereby imparting high light transmittance and improving thermal resistance of the photosensitive polyimide. Also, the solution loss of any epoxy included with the photosensitive polyimide in an adhesive composition may be reduced by curing the photosensitive polyimide with an epoxy so that the photosensitive polyimide can additionally have high adhesion.

The aromatic polyimide backbone may include a repeating unit A represented by Formula 1-1, Formula 1-2, Formula 1-3, or any combination thereof.

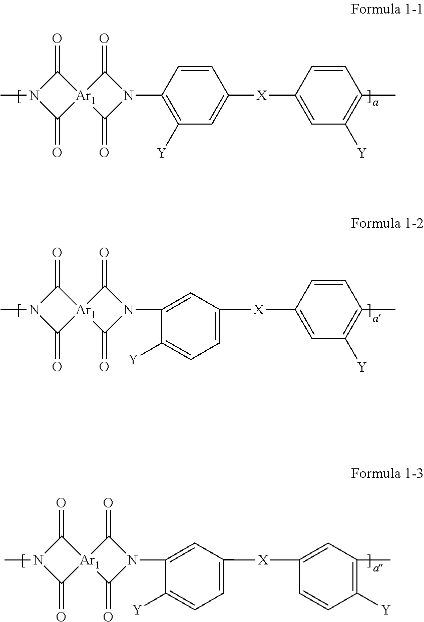

In Formulae 1-1, 1-2, and 1-3, Ar₁ is a quaternary organic group. Ar₁ may include a quaternary organic group having 4 or more carbon atoms, or 4 to 30 carbon atoms, and includes an aromatic ring. The aromatic ring in Ar₁ may be a single ring, may be two or more aromatic rings fused together to form a polycyclic aromatic group, or may be joined to each other by a single bond or linked through intervening groups including heteroatoms such as O, N, S, Si, or the like, carbonyl-containing groups such as aldehyde, ketone, ester, and amide groups, alkyl groups having 1 to 20 carbon atoms, aryl groups having 6 to 20 carbon atoms, and aralkyl groups having 7 to 20 carbon atoms. Ar₁ may be the reaction product of, for example, a tetra carboxylic acid dianhydride having a quaternary functional group. Also in Formulae 1-1, 1-2, and 1-3, a, a′, and a″ are each independently an integer of one or more, or 2 or more, or 5 or more.

In Formulae 1-1, 1-2, and 1-3, exemplary Ar₁ groups may be selected from the group consisting of:

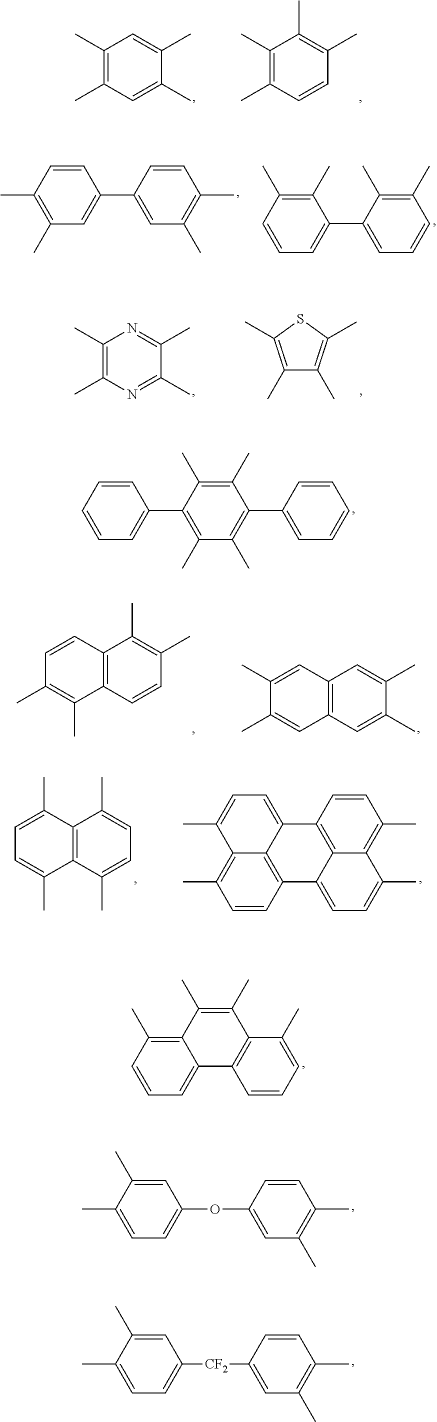

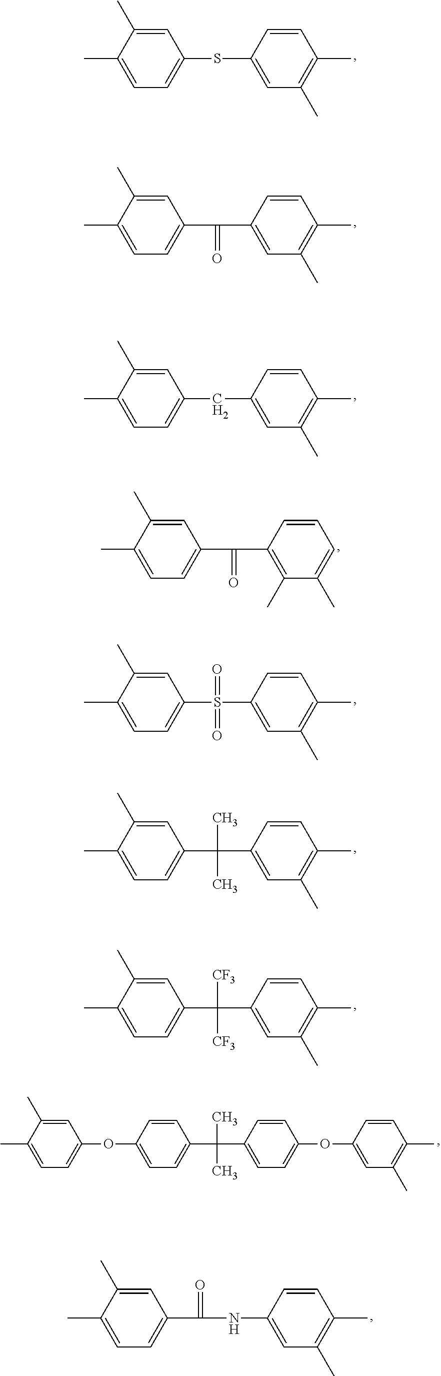

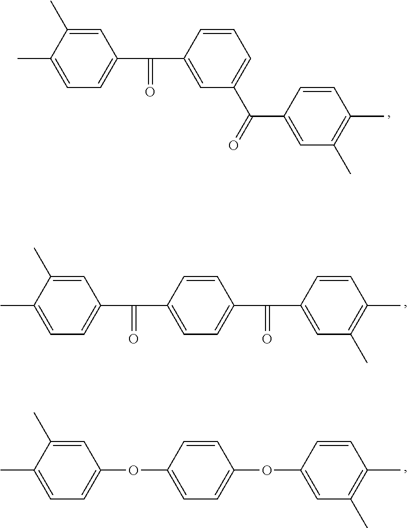

and any combination thereof, where it will be understood that all unassigned bonds in the foregoing structures for Ar₁ represent points of attachment to carboxyl groups in Formulae 1-1, 1-2, and 1-3.

In Formulae 1-1, 1-2, and 1-3, X may be selected from the group consisting of:

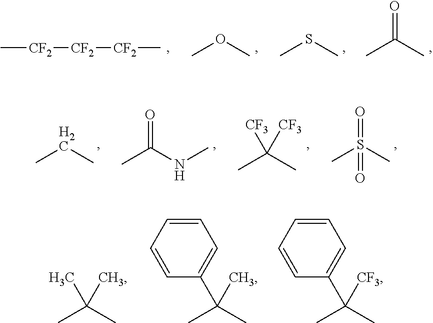

and any combination thereof, where it will be understood that all unassigned bonds in-the foregoing structures for X represent points of attachment to adjacent aromatic rings in Formulae 1-1, 1-2, and 1-3.

Also in Formulae 1-1, 1-2, and 1-3, at least one Y is derived from a functional group such as —OH, —NH₂, —SH, or a combination comprising at least one of the foregoing, and hence in these Formulae may include —O—, —S—, or a combination comprising at least one of the foregoing. A first side chain, or a second side chain, may be covalently linked to any one functional group Y. It will be understood that where a side chain is not attached to a functional group Y, the functional group Y may terminate in a hydrogen atom.

The aromatic polyimide backbone is prepared by the reaction of a tetracarboxylic acid anhydride represented by Formula 2 with a diamine. In Formula 2, Ar₁ is a quaternary organic group as defined for Formulae 1-1, 1-2, and 1-3.

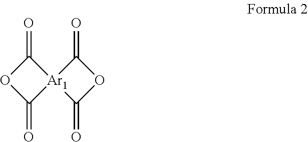

Exemplary aromatic dianhydrides of Formula 2 include pyromellitic dianhydride (PMDA), 3,3′,4,4′-biphenyltetracarboxylic dianhydride, 2,2′,3,3′-biphenyltetracarboxylic dianhydride, 2,3,3′,4′-biphenyltetracarboxylic dianhydride, 1,2,4,5-benzenetetracarboxylic dianhydride, 3,3′,4,4′-benzophenonetetracarboxylic dianhydride, 2,2′,3,3′-benzophenonetetracarboxylic dianhydride, 2,3,3′,4′-benzophenonetetracarboxylic dianhydride (BPDA), bis(3,4-dicarboxyphenyl)ether dianhydride, bis(3,4-dicarboxyphenyl)sulfone dianhydride, 1,4,5,8-naphthalenetetracarboxylic dianhydride, 1,2,5,6-naphthalenetetracarboxylic dianhydride, 2,3,6,7-naphthalenetetracarboxylic dianhydride, 2,2-bis(3,4-dicarboxyphenyl)-1,1,1,3,3,3-hexafluoropropane dianhydride, and the like, and a combination comprising at least one of the foregoing.

The aromatic dianhydride may be, for example, pyromellitic dianhydride (PMDA) or a benzophenone tetracarboxylic dianhydride (BPDA).

The diamine of Formulae 1-1, 1-2, and 1-3 is a bis-aminophenyl compound diamine having the structure of Formulae 1-1a, 1-2a, and 1-3a:

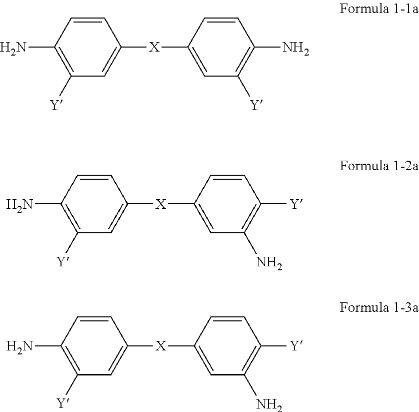

Where, in Formulae 1-1a, 1-2a, and 1-3a, X is as described for Formulae 1-1, 1-2, and 1-3, and Y′ is selected from the group consisting of —OH, —NH₂, —SH, and any combination thereof.

Exemplary diamines which may react with Formula 2 to provide Formulae 1-1, 1-2, and 1-3 include 3,3′-diamino-4,4′-dihydroxy diphenyl ether, 3,4′-diamino-3′,4-dihydroxy diphenyl ether, 4,4′-diamino-3,3′-dihydroxy diphenyl ether, 3,3′-diamino-4,4′-dihydroxy diphenyl methane, 3,4′-diamino-3′,4-dihydroxy diphenyl methane, 3,3′-diamino-4,4′-dihydroxy diphenyl sulfide, 3,3′-diamino-4,4′-dihydroxy diphenyl ketone, 3,4′-diamino-3′,4-dihydroxy diphenyl ketone, 4,4′-diamino-3,3′-dihydroxy diphenyl ketone, 2,2-bis(3-diamino-4-hydroxy phenyl)propane, 2-(3-amino-4-hydroxy phenyl)-2-(4-amino-3-hydroxy phenyl)propane, 2,2-bis(4-amino-3-hydroxy phenyl)propane, 2,2-bis(3-amino-4-hydroxyphenyl)-1,1,1,3,3,3-hexafluoro propane, 2,2-bis(4-amino-3-hydroxy phenyl)-1,1,1,3,3,3-hexafluoro propane, 2-(3-amino-4-hydroxy phenyl)-2-(4-amino-3-hydroxy phenyl)-1,1,1,3,3,3-hexafluoro propane, 1,3-bis(3-amino-4-hydroxy phenoxy)benzene, 1,4-bis(3-amino-4-hydroxy phenoxy)benzene, 2,2-bis(4-(3-amino-4-hydroxy phenoxy) phenyl)propane, 2,2-bis(4-(3-amino-4-hydroxy phenoxy)phenyl)-1,1,1,3,3,3-hexafluoro propane, 2,2-bis(4-(4-amino-3-hydroxy phenoxy)phenyl)-1,1,1,3,3,3-hexafluoro propane, 3,3′,4,4′-tetraamino diphenyl ether, 3,3′,4,4′-terraamino-4,4′-dihydroxy diphenyl sulfide, 3,3′,4,4′-tetraamino diphenyl ketone, 2,2-bis(3,4-diamino phenyl)propane, 2,2-bis(3,4-diamino phenyl)-1,1,1,3,3,3-hexafluoro propane, 1,3-bis(3,4-diamino phenoxy)benzene, 1,4-bis(3,4-diamino phenoxy)benzene, 2,2-bis(4-(3,4-diamino phenoxy) phenyl)propane, 2,2-bis(4-(3,4-diamino phenoxy)phenyl)-1,1,1,3,3,3-hexafluoro propane, 3,3′-diamino-4,4′-dimercapto diphenyl ether, 3,4′-diamino-3′,4-dimercapto diphenyl ether, 4,4′-diamino-3,3′-dimercapto diphenyl ether, 3,3′-diamino-4,4′-dimercapto diphenyl methane, 3,4′-diamino-3′,4-dimercapto diphenyl methane, 3,3′-diamino-4,4′-dimercapto diphenyl sulfide, 4,4′-diamino-3,3′-dimercapto diphenyl sulfide, 3,3′-diamino-4,4′-dimercapto diphenyl ketone, 4,4′-diamino-3,3′-dimercapto diphenyl ketone, 2,2-bis(3-diamino-4-mercapto phenyl)propane, 2-(3-amino-4-mercapto phenyl)-2-(4-amino-3-mercapto phenyl) propane, 2,2-bis(4-amino-3-mercapto phenyl)propane, 2,2-bis(3-amino-4-mercaptophenyl)-1,1,1,3,3,3-hexafluoro propane, 2,2-(3,4′-diamino--3′,4-dimercapto diphenyl)-1,1,1,3,3,3-hexafluoro propane, 2-(3-amino-4-mercapto phenyl)-2-(4-amino-3-mercapto phenyl)-1,1,1,3,3,3-hexafluoro propane, 1,3-bis(3-amino-4-mercapto phenoxy)benzene, 1,4-bis(3-amino-4-mercapto phenoxy)benzene, 2,2-bis(4-(3-amino-4-mercapto phenoxy) phenyl)propane, 2,2-bis(4-(3-amino-4-mercapto phenoxy)phenyl)-1,1,1,3,3,3-hexafluoro propane, 2,2-bis(4-(4-amino-3-mercapto phenoxy)phenyl)-1,1,1,3,3,3-hexafluoro propane, or any combination thereof.

Imidization of Formula 2 with a diamine of Formulas 1-1a, ⁻1-2a, or 1-3a thus provides, respectively, a backbone structure including Formulae 1-1b, 1-2b, or 1-3b:

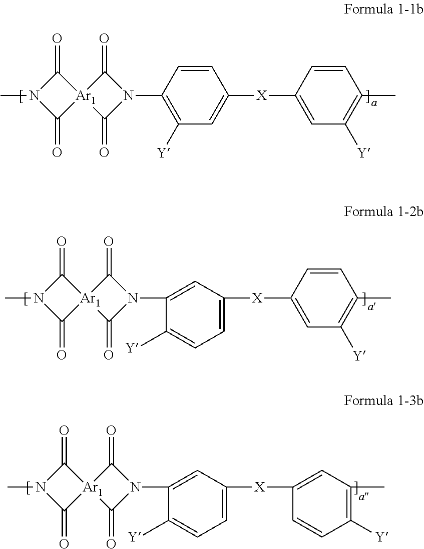

In Formulae 1-1b, 1-2b, and 1-3b, Ar₁ and X are independently as defined above for Formulae 1-1, 1-2, and 1-3, and Y′ may be selected from the group consisting of —OH, —SH, —NH₂, and any combination thereof, and a, a′, and a″ are each an integer of one or more, or 2 or more, or 5 or more. At least one of Y′ is then derivatized with a side chain to provide the aromatic polyimide having a repeating unit A of Formulae 1-1, 1-2, 1-3, or any combination comprising at least one of the foregoing.

In addition, the aromatic polyimide backbone may further include a repeating unit B, which is prepared by reacting a tetracarboxylic acid anhydride represented by Formula 2 with a diamine. The aromatic polyimide backbone may include a copolymer of the repeating units A and B.

Also, the diamine for repeating unit B may be selected from substituted or unsubstituted aromatic diamine, aliphatic ether diamine, diamino siloxane, and any combination comprising at least one of the foregoing. When the diamine is substituted, the substituent may be selected from hydrogen, an alkyl group having 1 to 20 carbon atoms, a hydroxyl group, a carboxyl group, an aromatic hydroxyl group, and any combination comprising at least one of the foregoing. When a diamine substituted with the hydroxyl group or the carboxyl group is introduced, the solubility of diamine in an alkali or organic solvent developing agent may increase. An aromatic diamine having a carboxylic acid group may include, for example, 3,4-diamino benzoic acid or 3,5-diamino benzoic acid, where the carboxylic acid reacts with an alkaline developer.

Examples of the aromatic diamine for repeating unit B may include o-phenylene diamine, m-phenylene diamine, p-phenylene diamine, 3,3′-diamino diphenyl ether, 3,4′-diamino diphenyl ether, 4,4′-diamino diphenyl ether, 3,3′-diamino diphenyl methane, 3,4′-diamino diphenyl methane, bis(4-amino-3,5-diisopropyl phenyl)methane, 3,3′-diamino diphenyl sulfide, 3,3′-diamino diphenyl ketone, 3,4′-diamino phenyl ketone, 4,4′-diamino diphenyl ketone, 2,2-bis(3-diamino phenyl)propane, 2-(3-amino phenyl)2(4-amino phenyl)propane, 2,2-bis(4-amino phenyl)propane, 2,2-bis(3-aminophenyl)-1,1,1,3,3,3-hexafluoro propane, 2-(3-amino phenyl)-2-(4-amino phenyl)-1,1,1,3,3,3-hexafluoro propane, 2,2-bis(4-aminophenyl)-1,1,1,3,3,3-hexafluoro propane, 1,3-bis(3-amino phenoxy)benzene, 1,4-bis(3-amino phenoxy)benzene, 2,2-bis(4-(3-amino phenoxy)phenyl)propane, 2,2-bis(4-(3-amino phenoxy)phenyl)-1,1,1,3,3,3-hexafluoro propane, 2,2-bis(4-(4-amino phenoxy)phenyl)-1,1,1,3,3,3-hexafluoro propane, or any combination comprising at least one of the foregoing.

The aromatic diamine may be, for example, oxydianiline (ODA), p-phenylene diamine (p-PDA), m-phenylene diamine (m-PDA), methylene dianiline (MDA), or 4,4′ (1,1,1,3,3,3-hexafluoroisopropylidene) bisphthalic anhydride (HFDA).

Examples of the aliphatic amine may include JEFFAMINE® D-230, JEFFAMINE® D-400, JEFFAMINE® D-2000, or JEFFAMINE® D-4000 available from Huntsman Corporation.

Examples of the diamino siloxane may include, but are not limited to, 1,1,3,3-tetramethyl-1,3-bis(4-aminophenyl)siloxane, 1,1,3,3,-tetraphenoxy-1,3-bis(4-aminoethyl)siloxane, 1,1,3,3-tetraphenyl-1,3-bis(2-aminoethyl)siloxane, 1,1,3,3,-tetraphenyl-1,3-bis(3-aminopropyl)siloxane, 1,1,3,3-tetramethyl-1,3-bis(2-aminoethyl)siloxane, 1,1,3,3-tetramethyl-1,3-bis(3-aminopropyl)siloxane, 1,1,3,3-tetramethyl-1,3-bis(3-aminobutyl)siloxane, 1,3-dimethyl-1,3-dimethoxy-1,3-bis(4-aminobutyl)siloxane. These diamino siloxanes may be used alone, or two or more may be used together. A combination comprising at least one of the foregoing may be used.

Examples of the repeating unit B may include repeating units represented by Formulae 2-1 and 2-2.

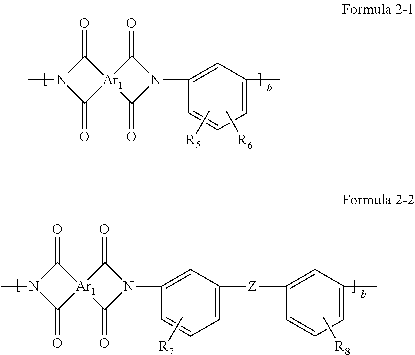

In Formulae 2-1 and 2-2, Ar₁ is a quaternary organic group as defined in Formula 1. Also in Formulae 2-1 and 2-2, b is an integer of one or more, or 2 or more, or 5 or more.

Z may be selected from the group consisting of:

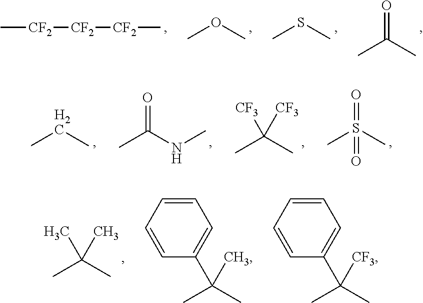

and any combination thereof, where it will be understood that all unassigned bonds in the foregoing structures for Z represent points of attachment to adjacent aromatic rings in Formulae 2-1 and 2-2.

R₅, R₆, R₇, and R₈ may be independently selected from the group consisting of hydrogen, an alkyl group having 1 to 20 carbon atoms, a hydroxyl group, carboxyl group, an aromatic hydroxyl group, and any combination thereof.

The aromatic polyimide backbone may include, but is not limited to, a block copolymer, random copolymer, or alternating copolymer of the repeating units A and B. In further embodiments, the aromatic polyimide may be a di-, tri-, tetra-, etc. block copolymer in which each block is a homopolymer, alternating copolymer, or random copolymer.

The molar ratio of the repeating units A and B may depend on the use of an adhesive composition. The molar ratio of A and B (expressed as a mole-fraction per one mole of repeating units) may be from 0.1:99.9 to 99.9:0.1. The repeating unit A includes the functional group Y to which first and second side chains may be introduced, and as the ratio of the repeating unit A increases, photosensitivity and solubility in a solvent may also increase. Furthermore, since the repeating unit B constitutes a diamine backbone and optionally includes a group that is soluble in or improves solubility in an alkali or organic solvent developing agent, as the ratio of the repeating unit B increases, strength and rigidity may improve and the solubility in the developing agent may increase. Thus, the molar ratio of the repeating units A and B may be appropriately controlled in consideration of the above. When the molar ratios of the repeating units A and B are respectively a and b, a and b may be, for example, 0.30≦a/(a+b)≦0.98 and 0.02≦b/(a+b)≦0.70, or 0.50≦a/(a+b)≦0.98 and 0.02≦b/(a+b)≦0.50.

In the aromatic polyimide backbone, a first side chain including a (meth)acryloyl group is grafted to a unit A of the backbone. The first side chain including the (meth)acryloyl group may have a (meth)acryloyl group and an amide group.

The first side chain including the (meth)acryloyl group may be grafted onto the repeating unit A of the aromatic polyimide backbone, where the repeating unit A is of Formulae 1-1, 1-2, and/or 1-3.

The first side chain including the (meth)acryloyl group may be a compound represented by Formula 3.

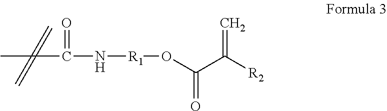

In Formula 3, R₁ may be selected from the group consisting of alkylene having 1 to 10 carbon atoms, —Rₐ—OR_{b}—, —Rₐ—C(═O)OR_{b}—, —Rₐ—OC(═O)R_{b}—, and any combination thereof. Rₐ and R_{b} may be independently alkylene having 1 to 6 carbon atoms. R₁ may further include a substituent selected from the group consisting of hydrogen, alkyl having 1 to 10 carbon atoms, —R′—OR″—, —R′—C(═O)OR″, —R′—OC(═O)R″, —R′—OC(═O)C(═CH₂)R″, and any combination thereof. R′ may be independently alkylene having 1 to 6 carbon atoms, and R″ may be independently hydrogen or alkyl having 1 to 6 carbon atoms, and R₂ may be hydrogen or methyl. As used herein, a doubled line (══) represents a broken bond showing the point of attachment of the graft to the polyimide backbone.

The compound represented by Formula 3 may be a compound represented by Formula 3-1 or 3-2.

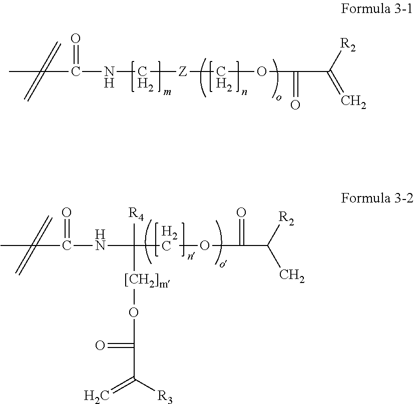

In Formulae 3-1 and 3-2, Z may be selected from the group consisting of a direct bond, —O—, —C(═O)O—, —OC(═O)—, and any combination thereof.

Also, m and m′ may be independently an integer of 1 to 5, n and n′ may be independently an integer of 0 to 5, and o and o′ may be independently an integer of 0 to 10. Provided that Z is —O—, —C(═O)O—, or —OC(═O)—, n and o are not 0, R₂ and R₃ are independently hydrogen or methyl, and R₄ is hydrogen or alkyl having 1 to 6 carbon atoms.

The compound represented by Formula 3-1 or 3-2 may include, but is not limited to, a compound represented by one of Formulae 3-3 to 3-5.

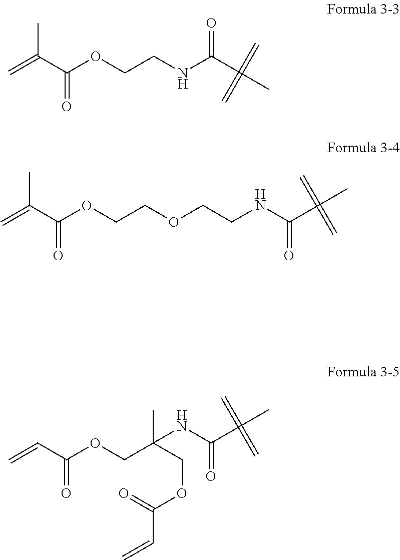

In the photosensitive polyimide, a side chain represented by Formula 3-1 or 3-2 is grafted onto Y of an aromatic polyimide backbone represented by Formula 1-1 or 1-2.

The grafted (meth)acrylate compound is highly soluble in an organic solvent or alkali solution as a developing agent, and increases the solubility of the backbone in the organic solvent or alkali solution developing agent. Accordingly, the grafted (meth)acrylate compound may impart an improved patternability in the polyimide in pattern formation by exposure and development, and may decrease film thickness loss during development.

Also, in the aromatic polyimide backbone, a second side chain including a silicon-modified group may be grafted to unit A of the backbone. The second side chain including the silicon-modified group may include a silicon-modified group and an amide group.

The second side chain including the silicon-modified group may be grafted onto the repeating unit A of the aromatic polyimide backbone, where the repeating unit A is of Formulae 1-1, 1-2, and/or 1-3.

The second side chain including the silicon-modified group may be a compound represented by Formula 4.

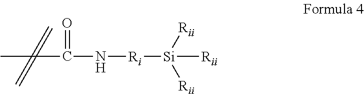

In Formula 4, R, may be selected from the group consisting of alkylene having 1 to 10 carbon atoms, —Rₐ—OR_{b}—, —Rₐ—C(═O)OR_{b}—, —Rₐ—OC(═O)R_{b}—, and any combination thereof. Rₐ and R_{b} may be independently alkylene having 1 to 6 carbon atoms. Rᵢ may further include a substituent selected from the group consisting of hydrogen, alkyl having 1 to 10 carbon atoms, —R′—OR″, —R′—C(═O)OR″, and —R′—OC(═O)R″, and any combination thereof. R′ may be independently alkylene having 1 to 6 carbon atoms, and R″ may be independently hydrogen or alkyl having 1 to 6 carbon atoms. Rᵢᵢ may be selected from the group consisting of hydrogen, alkyl having 1 to 10 carbon atoms, alkoxy having 1 to 10 carbon atoms, and any combination thereof.

Example of the silicon-modified group may be prepared by introducing at least one compound selected from the group consisting of triethoxysilyl isocyanate, trimethoxysilyl isocyanate, tetraethoxysilane, and any combination thereof.

The photosensitive polyimide may include the first side chain including the (meth)acryloyl group and the second side chain including the silicon-modified group in an appropriate ratio in consideration of patternability and adhesive property by the first side chain and thermal stability and an adhesive property by the second side chain. The photosensitive polyimide may include the first side chain and the second side chain in a molar ratio of, for example, about 1:9 to about 9:1.

The weight-average molecular weight (Mw) of the photosensitive polyimide may be about 5,000 to about 150,000 g/mol, or about 20,000 to about 100,000 g/mol. Weight averaged molecular weight is as determined by any method known in the art, such as by gel permeation chromatography using a crosslinked styrene-di vinylbenzene column and universal calibration method with polystyrene standards. When the weight-average molecular weight of the photosensitive polyimide is less than about 5,000 g/mol, the mechanical strength may decrease. When it exceeds about 150,000 g/mol, the solvent resistance may decrease.

2. Method of Preparing Photosensitive Polyimide

The photosensitive polyimide may be prepared by a known graft polymerization method, including condensation polymerization (esterification, amidization), addition polymerization (radical polymerization, urethane polymerization), metal catalyzed polymerization, and other such methods.

In an exemplary embodiment, the photosensitive polyimide may be prepared by urethane-polymerizing an aromatic polyimide main-chain backbone with a material including a (meth)acryloyl group and a material including a silicon-modified group.

As shown in Reaction Formula 1 for example, 2-methacryloyloxyethyl isocyanate (compound II) and 3-(triethoxysilyl)propyl isocyanate (compound III) may each be grafted onto an aromatic polyimide compound (compound I) as a backbone with a urethane reaction to prepare a photosensitive polyimide (compound IV).

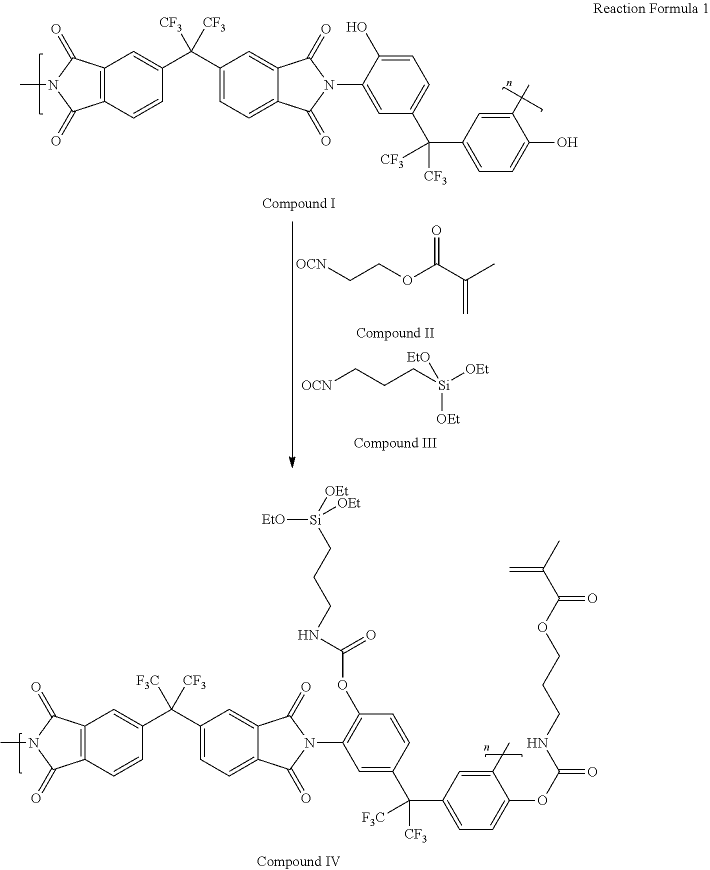

It will be appreciated that Reaction Formula 1 is exemplary, and the aromatic polyimide compound I may be, for example, any compound represented by Formulae 1-1b, 1-2b, 1-3b, or a combination comprising at least one of the foregoing. It will further be appreciated that, where a complete reaction of both hydroxyl groups of compound I is not desired, both side chains (compounds II and III) need not be attached to the same diamine-derived polyimide unit shown in compound I, but that a first unit of compound I may have a unit of compound II attached thereto, while a second unit of compound I may have a unit of compound III attached thereto, and that hydroxyl groups on compound I may remain ungrafted after the graft process. Further, compound I may also include repeating units in which two of compound II, or two of compound III, are attached to the same repeating unit of compound I; and conversely, units of compound I may remain unreacted after the graft process. It will be appreciated that a statistical mixture of these graft motifs may thus be obtained, with the population as a mole percentage of each individual graft species being dependent on the degree of grafting. The degree of grafting, it will be further appreciated, may be affected by the relative amounts of repeating units of compound I (i.e., “n”) and the relative amounts of compounds I and II used. While the above grafting distribution is described for exemplary compounds I, II, and III as shown, it will be understood that the above-described grafting distribution may be thus generally obtained for any combination of aromatic polyimide backbone and side chain described herein.

The method of preparing the aromatic polyimide compound is not particularly limited. The aromatic polyimide compound may be prepared by thermal solution imidization or chemical imidization of a diamine including a functional group of Formula 1-1a, 1-2a, and/or 1-3a, and an acid anhydride including a quaternary organic group of Formula 2. A polyamic acid derivative may first be prepared by polymerization of aromatic dianhydride with aromatic diamine or aromatic diisocyanate, followed by imidization by ring closure and dehydration at a high temperature.

In an exemplary example, the aromatic polyimide may be prepared by combining an aromatic dianhydride and an aromatic diamine in an organic solvent at a reaction temperature of about 80° C. or lower, or about 0 to about 60° C. The order of addition of each component may be arbitrarily determined. As the, viscosity of the reaction solution gradually increases over the course of the reaction, polyamic acid is produced as a precursor of polyimide. The resulting polyamic acid may be heated to a temperature of about 50 to about 80° C. during polymerized to adjust the molecular weight. Thereafter, the resulting polyamic acid may be ring-closed and dehydrated to produce the aromatic polyimide. The ring closure and dehydration of the polyamic acid may be performed by thermal ring closure using heat, or by chemical ring closure using dehydration.

In this connection, Reaction Formula 2 schematically shows a method of preparing the compound I represented generally by Formula 1-3b.

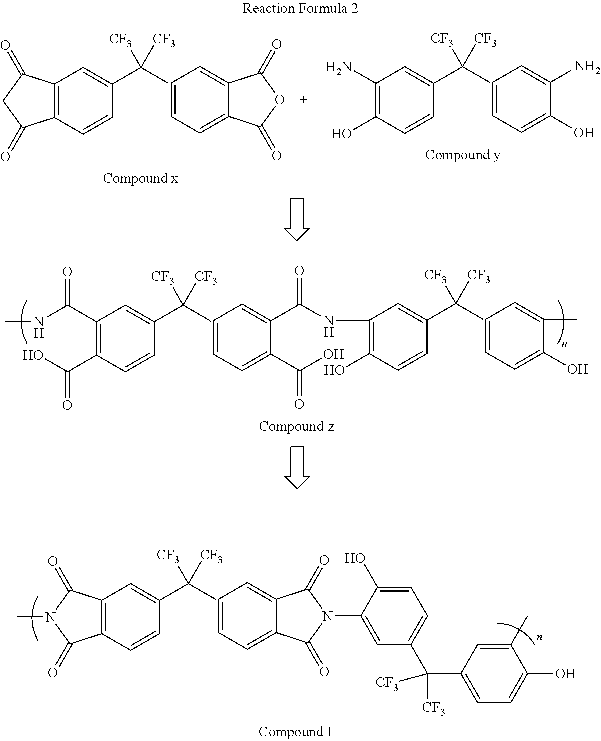

Referring to Reaction Formula 2, the polyamic acid (compound z) is prepared by reacting 4,4′-(1,1,1,3,3,3-hexafluoroisopropylidene)diphthalic anhydride (compound x) and 2,2-bis(3-amino-4-hydroxyphenyl)-1,1,1,3,3,3-hexafluoropropane (compound y), to form the polyamic acid (compound z), and compound z may be imidized using dehydration and ring closure to produce aromatic polyimide (Compound I).

The mixture ratio of aromatic dianhydride to aromatic diamine is not particularly limited. For example, about 0.5 to about 2.0 mol or about 0.8 to about 1.2 mol of aromatic diamine may be added to about 1 mol of aromatic dianhydride. When the ratio of aromatic diamine-exceeds about 2.0 mol, polyimide oligomers having predominantly a terminal amino group may be produced, while when it is less than about 0.5 mol, polyimide oligomers having predominantly terminal acid anhydride groups may be produced. When the amount of these polyimide oligomers increases, the weight-average molecular weight of the polyimide decreases, and the desired properties, such as the thermal resistance of the photosensitive adhesive composition, are impaired. Thus, by adjusting the ratio of aromatic dianhydride to aromatic diamine, the weight-average molecular weight of the polyimide may be adjusted to be from about 5,000 to about 150,000 g/mol.

Meanwhile, the (meth)acrylate compound may be a (meth)acrylate compound including an isocyanate group as represented by Formula 5.

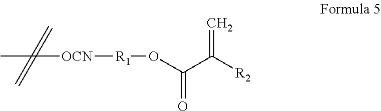

In Formula 5, R₁ may be selected from the group consisting of alkylene having 1 to 10 carbon atoms, —Rₐ—OR_{b}—, —Rₐ—C(═O)OR_{b}—, —Rₐ—OC(═O)R_{b}—, and any combination thereof, and Rₐ and R_{b} may be independently alkylene having 1 to 6 carbon atoms. R₁ may further include a substituent selected from the group consisting of hydrogen, alkyl having 1 to 10 carbon atoms, —R′—OR″—, —R′—C(═O)OR″, —R′—OC(═O)R″, —R′—OC(═O)C(═CH₂)R″, and any combination thereof. Rₐ and R_{b} may be independently alkylene having 1 to 6 carbon atoms. R′ may be independently alkylene having 1 to 6 carbon atoms, R″ may be independently hydrogen or alkyl having 1 to 6 carbon atoms, and R₂ may be hydrogen or methyl.

The compound of Formula 5 may be, for example, a compound represented by Formula 5-1 or 5-2.

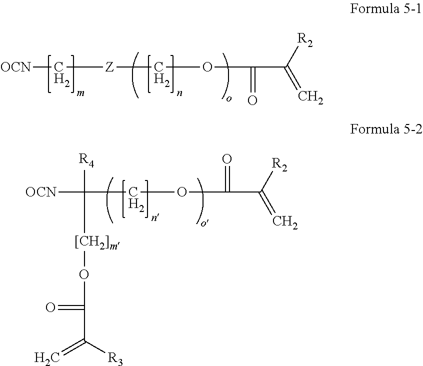

In Formulae 5-1 and 5-2, Z may be selected from the group consisting of a direct bond, —O—, —C(═O)O—, and —OC(═O)—; m and m′ may be independently an integer of 1 to 5, and n and n′ may be independently an integer of 0 to 5, and o and o′ may be an integer of 0 to 10. Provided that Z is —O—, —C(═O)O—, or —OC(═O)—, n and o are not 0, R₂ and R₃ independently hydrogen or methyl, and R₄ is hydrogen or alkyl having 1 to 6 carbon atoms.

Also, the compound represented by Formula 5-1 may be methacryloyloxyethyl isocyanate represented by Formula 5-3 or a compound represented by Formula 5-4.

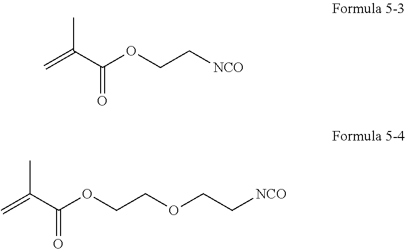

Alternatively, the compound represented by Formula 5-2 may be a compound represented by Formula 5-5.

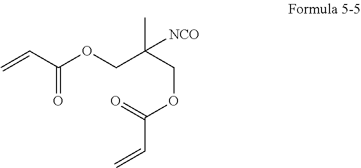

As described above, the photosensitive polyimide may be prepared by reacting aromatic polyimide having a certain functional group as a side-chain with a methylacrylate-based compound having a functional group. For example, the photosensitive polyimide may be prepared by graft polymerization through a urethane reaction.

For example, since the compound represented by Formula 4b-1 includes a hydroxyl group in the position of Y′, a urethane reaction between the compound represented by Formula 4a′-1 and a (meth)acrylate-based compound having an isocyanate group, for example, the compound represented by Formula 5, may be formed. Then, a urethane reaction catalyst may be added during the urethane reaction.

Also, the silicon-modified compound may be a silane compound including an isocyanate group as represented by Formula 6.

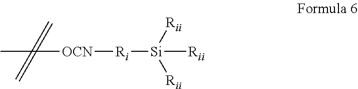

In Formula 6, R₁ may be selected from the group consisting of alkyl having 1 to 10 carbon atoms, —Rₐ—OR_{b}—, —Rₐ—C(═O)OR_{b}—, —Rₐ—OC(═O)R_{b}—, and any combination thereof, and Rₐ and R_{b} may be independently alkylene having I to 6 carbon atoms, and Rᵢ may include a substituent selected from the group consisting of hydrogen, alkyl having 1 to 10 carbon atoms, —R′—OR″—, —R′—C(═O)OR″—, —R′—OC(═O)R″—, and any combination thereof. R′ may be independently alkylene having 1 to 6 carbon atoms, and R″ may be independently hydrogen or alkyl having 1 to 6 carbon atoms. Rᵢᵢ may be selected from the group consisting of hydrogen, alkyl having 1 to 10 carbon atoms, alkoxy having 1 to 10 carbon atoms, and any combination thereof.

If necessary, the prepared photosensitive polyimide may be further copolymerized with a typical polyimide or aromatic polyimide.

3. Adhesive Composition

An adhesive composition includes the photosensitive polyimide having a silicon-modified group.

The adhesive composition may further include at least one selected from the group consisting of an organic solvent, a photocurable acrylate-based compound, a binder, thermal-curing agent, a photo-initiator, a photoacid generator, and any combination thereof, in addition to the photosensitive polyimide having a silicon-modified group.

An adhesive composition including the photosensitive polyimide having a silicon-modified group may form a silicon oxide crosslinking structure during UV curing and thermal-curing adhesion, thus have a high thermal stability, i.e., a decomposition temperature of 200° C. or more, or 250° C. or more, and a low coefficient of thermal expansion (CTE) of 400 ppm/° C. or less, when measured at a temperature of 50 to 200° C. A binder unit maybe chemically combined with a thermal curing unit by reaction of epoxy and siloxane due to a photoacid, thus solution loss (e.g., as measured by film thickness loss) of the thermal curing unit may be reduced during development, and the adhesive property may be improved.

The adhesive composition may have total solids of about 1 to about 40 parts by weight with respect to the organic solvent. Also, the adhesive composition may include, for example, about 5 to about 40 parts by weight of the photosensitive polyimide-based compound, about 10 to about 30 parts by weight of the photocurable acrylate compound, about 5 to about 40 parts by weight of a binder, about 10 to about 50 parts by weight of a thermal-curing agent, about 0.1 to about 10 parts by weight of a photo-initiator, and about 0.1 to about 10 parts by weight of a photo-acid generator.

The organic solvent may be used in order to uniformly dissolve or disperse materials. For example, the organic solvent may include N,N-dimethyl formamide, dimethyl sulfoxide, sulfolane, toluene, benzene, xylene, methyl ethyl ketone, methylisobutyl ketone, tetrahydrofuran (“THF”), ethyl acetate, ethyl cellosolve, ethyl cellosolve acetate, dioxane, dioxolane, cyclohexanone, N-methyl-pyrrolidinone, or any combination comprising at least one of the foregoing.

The photocurable acrylate-based compound may be, for example, a (meth)acrylate compound having carbon-carbon double bonds.

For example, the photocurable acrylate-based compound may include, but is not limited to, methyl(meth)acrylate, ethyl(meth)acrylate, n-butyl(meth)acrylate, isobutyl(meth)acrylate, 2-ethylhexyl(meth)acrylate, isooctyl(meth)acrylate, glycidyl (meth)acrylate, cyclohexyl(meth)acrylate, isobornyl(meth)acrylate, benzyl(meth)acrylate, 2-hydroxyethyl(meth)acrylate, 2-hydroxypropyl(meth)acrylate, trimethoxybutyl(meth)acrylate, ethyl carbitol(meth)acrylate, phenoxyethyl(meth)acrylate, 2-(2-hydroxyethoxy)ethyl(meth)acrylate, trimethylolpropane(meth)acrylate, tetramethylolmethane tetra(meth)acrylate, pentaerythritol hexa(meth)acrylate, pentaerythritol tetra(meth)acrylate, dipentaerythritol penta(meth)acrylate, dipentaerythritol hexa(meth)acrylate, 1,2-ethane di(meth)acrylate, 1,3-propane di(meth)acrylate, 1,4-butane di(meth)acrylate, 1,6-hexane di(meth)acrylate, polyethylene glycol di(meth)acrylate, oligoester(meth)acrylate, polyfunctional urethane(meth)acrylate, or urea acrylate.

The binder may include, but is not limited to, a polyester-based binder, a urethane-based binder, a silicon-based binder, a natural rubber-based binder, an acrylic-based binder, or any combination thereof. Also, the binder may have a glass transition temperature of about −20 to 60° C. and a weight-average molecular weight (Mw) of about 100,000 g/mol to about 1,000,000 g/mol, as determined by GPC.

In an exemplary example, the binder may include a UV-curable acrylate part and a silane functional group in a branch shape so that the binder may be applied as a solution in an organic solvent or as an alkali-developed composition. Alternatively, the binder may be an acrylate binder, which has a weight-average molecular weight of about 30,000 to about 300,000 g/mol, and which includes an acryloyl group or methacryloyl group present in an equivalent weight of about 50 to about 1,000 g/eq of (meth)acryloyl group. The acrylate-based binder may have side chains, which can introduce various functional groups and exhibit good film formability.

The adhesive composition may also include other additive such as, for example, a thermosetting resin, a curing agent for curing the thermosetting resin, and additives such as a hardening accelerator and a catalyst.

The thermosetting resin may be, for example, a multifunctional epoxy resin and/or a resin having at least two epoxy groups in the molecule.

For example, the epoxy resin may include a bisphenol A epoxy resin, a brominated epoxy resin, a novolac epoxy resin, a bisphenol F epoxy resin, a hydrogen-added bisphenol A resin, a glycidylamine epoxy resin, an alicyclic epoxy resin, a trihydroxyphenyl methane-type epoxy resin, a bixylenol or biphenol epoxy resin, a bisphenol S epoxy resin, a bisphenol-A novolac epoxy resin, a tetraphenylol ethane epoxy resin, a diglycidylphthalate resin, a naphthalene-containing epoxy resin, an epoxy resin having a dicyclopentadiene backbone, or any combination comprising at least one of the foregoing.

The curing agent may be a phenol-based compound, aliphatic amine, alicyclic amine, aromatic polyamine, polyamide, aliphatic acid anhydride, alicyclic acid anhydride, aromatic acid anhydride, dicyan diamide, a boron trifluoride-amine complex, imidazoles, tertiary amine, and the like, or a combination comprising at least one of the foregoing. Alternatively, the curing agent may be a phenol-based compound, which may have good developing properties in an organic solvent or alkaline developer, and at least two phenolic hydroxyl groups in the molecule. For example, the curing agent may be a phenol novolac resin, a cresol novolac resin, a t-butyl phenol novolac resin, a xylene-modified novolac resin, a naphthol novolac resin, a trisphenol novolac resin, a tetrakis phenol novolac resin, a bisphenol-A novolac resin, a poly-p-vinyl phenol resin, a phenol aralkyl resin, or a trisphenol compound.

The hardening accelerator or catalysts are not particularly limited, provided that they may accelerate the curing of an epoxy resin. For example, the hardener or catalyst may include imidazoles, dicyan diamide derivatives, dicarboxylic acid dihydride, triphenyl phosphine, tetra phenyl phosphonium tetra phenylborate, 2-ethyl-4-methyl imidazole-tetra phenylborate, or any combination comprising at least one of the foregoing.

The photopolymerization initiator preferably has an absorption band at about 400 nm and may be used to form a highly precise pattern during UV exposure. For example, the photopolymerization initiator may include 1-hydroxy-cyclohexyl-phenyl-ketone, 2-hydroxy-2-methyl-1-phenyl-1-propanone, 2-hydroxy-1-[4-(2-hydroxyethoxyl)phenyl]-2-methyl-1-propanone, methylbenzoylformate, α,α-dimethoxy-α-phenylacetophenone, 2-benzyl-2-(dimethylamino)-1-[4-(4-morpholinyl)phenyl]-1-butanone, 2-methyl-1-[4-(methylthio)phenyl[-2-(4-morpholinyl)-1-propanone, diphenyl (2,4,6-trimethylbenzoyl)-phosphine oxide, phosphine oxide, or any combination comprising at least one of the foregoing.

The photo-acid generator may generate acids during UV irradiation, where the photogenerated acid may at least partially cure any included epoxy resin. The photo-acid generator may preferably include aromatic iodonium salts, aromatic sulfonium salts, or a combination comprising at least one of the foregoing.

For example, the photo-acid generator may be di(t-butylphenyl)iodonium triflate, diphenyliodonium tetrakis(pentafluorophenyl)borate, diphenyliodonium hexafluorophosphate, diphenyliodonium hexafluoro antimonate, di(4-nonylphenyl)iodonium hexafluorophosphate, [4-(octyloxy)phenyl]phenyliodonium hexafluoroantimonate, triphenylsulfonium triflate, triphenylsulfonium hexafluorophosphate, triphenylsulfonium hexafluoroantimonate, triphenylsulfonium tetrakis(pentafluorophenyl)borate, 4,4′-bis[diphenylsulfonium]diphenylsulfide, bis-hexafluorophosphate, hydroxyethoxy)phenylsulfonium]diphenylsulfide bis-hexafluoroantimonate, hydroxyethoxy)(phenylsulfonium)]diphenyl sulfide bishexafluorophosphate, 7-[di(p-tolyl)sulfonium]-2-isopropylthioxanthone hexafluorophosphate, 7-[di(p-tolyl)sulfonio -2-isopropylthioxanthone hexafluoroantimonate, 7-[di(p-tolyl)sulfonium]-2-isopropyl tetrakis(pentafluorophenyl)borate, phenylcarbonyl-4′-diphenylsulfonium diphenylsulfide hexafluorophosphate, phenylcarbonyl-4′-diphenylsulfonium diphenylsulfide hexafluoroantimonate, 4-tert-butylphenylcarbonyl-4′-diphenylsulfonium diphenylsulfide hexafluorophosphate, 4-tert-butylphenylcarbonyl-4′-diphenylsulfonium diphenylsulfide hexafluoroantimonate, 4-tert-butylphenylcarbonyl-4′-diphenylsulfonium diphenylsulfide tetrakis(pentafluorophenyl)borate, diphenyl[4-(phenylthio)phenyl]sulfonium hexafluoroantimonate, or any combination comprising at least one of the foregoing. When the amount of the photoacid generator is less than 0.1 parts by weight, it is difficult to obtain sufficient photocurability. When the amount of the photoacid generator exceeds 0.1 parts by weight, photocurability may be impaired by light absorption of the photoacid generator.

In some cases, the adhesive composition may contain a coupling agent to increase adhesive strength. For example, the coupling agent may be a silane coupling agent capable of imparting high adhesive strength to the adhesive composition. Exemplary such coupling agents include vinyltrimethoxysilane, 3-trimethoxysilylpropyl(meth)acrylate, glycidoxypropyltrimethoxysilane, and the like, and any combination comprising at least one of the foregoing.

Also, the adhesive composition may contain organic or inorganic fillers. For instance, the adhesive composition may contain an inorganic filler, such as silica, alumina, boron nitride, titanium dioxide, glass, iron oxide, boron-aluminum compounds, ceramics, a rubber-based filler, and the like, and any combination comprising at least one of the foregoing.

The adhesive composition according to the exemplary example may contain a photosensitive polyimide as described hereinabove. Thus, the adhesive composition may have good characteristics of a polyimide resin such as photosensitivity, thermal resistance, and solubility in an organic solvent or alkaline developer.

The adhesive composition may be used in various fields in which a polyimide resin is generally used, such as for example in thermal-resistant high-technology materials such as automobile materials, aerial materials, and spacecraft materials; and in electronic materials, such as insulating coating materials, insulating layers, semiconductor materials, and electrode protection layers of thin-film-transistor liquid crystal displays (“TFT-LCDs”). Also, the adhesive composition may be employed as display materials, such as optical fibers or liquid crystal (“LC”) alignment layers, or used in transparent electrode films in or on which conductive fillers are contained or applied.

Furthermore, the photosensitive polyimide may have excellent photosensitivity, close adhesion with a base material, thermal resistance, and electrical insulation properties. Thus, the adhesive composition may be employed as an adhesive film for a semiconductor package, a protection layer for electrical and electronic components and semiconductor devices, an interconnection protection layer, or as a photoresist.

In addition, the adhesive composition may be adopted as an organic insulating composition or organic thin film transistor (“TFT”), which may be formed as a thin layer using a low-temperature wet process.

Moreover, the adhesive composition may be used as an organic light emitting diode (“OLED”) insulating layer. For example, when an insulating layer is prepared by depositing an organic emission material for an OLED, applying the adhesive composition in the entire region excluding a pixel forming region, and then curing the adhesive composition, the adhesive composition may define the shape of the pixels so that the respective pixels may be electrically isolated from one another.

4. Adhesive Film

An adhesive film is prepared by applying the adhesive composition in a solvent onto a base material, and then removing the solvent.

Since a conventional polyimide film may be contract or expand at a high temperature (i.e., may have a high CTE), use of conventional polyimides may be problematic in applications which require thermal dimensional stability.

An adhesive film according to the exemplary embodiment includes photosensitive polyimide having a silicon-modified group, and thus have very high thermal resistance and a low CTE relative to that of a conventional polyimide due to the rigidity of the imide backbone and the radical-induced crosslinking reaction of a grafted (methyl)acrylate-based compound. A silicon oxide crosslinking structure may further be formed during UV-curing and thermal-curing adhesion processes such that the adhesive film can have a high thermal stability and a low CTE. A binder unit may be chemically combined with a thermal curing unit by the photoacid-mediated reaction of epoxy and siloxane so that solution loss of the thermal curing unit (e.g., as measured by film thickness loss) can be reduced during development, and so that the thermal curing unit may be incorporated more fully into the adhesive film and thus contribute to the improvement in adhesive property obtained by use of the adhesive composition.

The base material may be, but not limited to, polyesters such as polyethylene terephthalate (PET), polyolefins including polyethylene, polypropylene, poly(ethylene-propylene), poly(ethylene-alpha olefin) copolymers, polyamides, polycarbonates, polyacrylates, polyvinyl ethers, fluorinated polymers such as polytetrafluoroethane (PTFE) and copolymers thereof with ethylene, poly(fluoro vinyl ethers) (PFA), and the like; ceramics; glasses; semiconductors such as silicon, gallium arsenide, and the like; silica; metals such as aluminum, copper, gold, molybdenum, nickel, zinc, titanium, tungsten, alloys thereof, and the like; and any combination comprising at least one of the foregoing.

For example, in an exemplary embodiment, the adhesive film may prepared by applying a solution of the adhesive composition onto a film having a certain thickness using a roll coater or bar coater, removing the solvent, and then thermally laminating an upper protection film to the adhesive film under pressure. Since the resulting adhesive film is excellent in not only adhesion but also a patternability and thermal resistance, the adhesive film may be used in a semiconductor package.

5. Semiconductor Package and Method of Manufacturing the Same

A semiconductor package as disclosed herein includes the adhesive composition and/or adhesive film, and a method of manufacturing the same.

For example, the semiconductor package may be manufactured by applying the adhesive composition onto a semiconductor chip or a base material, or attaching the adhesive film to the semiconductor chip, and then adhering the semiconductor chip to the adhesive film. It will be understood that the surface of the semiconductor chip that does not have devices (e.g., transistors, wiring, passivation layers, etc.) thereon is the preferred surface for adhering to the adhesive film.

The base material may include, but is not limited to, a silicon wafer, a plastic substrate, or a ceramic circuit board.

According to one example, the semiconductor package may include a plurality of semiconductor chips, and an adhesive layer formed between each of the semiconductor chips and the base material which is formed by curing the adhesive composition or the adhesive film.

As the adhesive layer may be formed by disposing the adhesive film on the semiconductor chip and then curing the adhesive film by thermal compression (i.e., by applying pressure while heating). In this way, a crosslinking reaction between resins of the adhesive film may occur during the curing.

The photosensitive polyimide contains a backbone in which a rigid aromatic polyimide repeating unit and a polyimide repeating unit may be block-copolymerized, and in which a (meth)acrylate side chain group is grafted onto the backbone. Alternatively, the backbone of the photosensitive polyimide may have any various arrangements of repeating units, such as a random copolymer structure, an alternating structure, or a combination of block and/or random and/or alternating copolymer arrangements.

The adhesive composition may be prepared by mixing photosensitive polyimide with a photocurable acrylate resin and then thermally curing. Radicals of the (meth)acrylate side chain group may then react with radicals of the photocurable acrylate resin to have a structure in which a photosensitive aromatic polyimide-based resin is crosslinked with the photocurable acrylate resin.

Since the photosensitive polyimide has a rigid imide backbone, it may have high strength and thermal resistance. Due to this high thermal resistance and hence thermal stability, the photosensitive polyimide has high dimensional stability after cure. Furthermore, since the (meth)acrylate compound is grafted, the photosensitive polyimide may have both high photosensitivity and solubility in an alkali solvent. Since the photosensitive polyimide may thus be dissolved in an alkali solution during development and in this way be removed, a highly precise pattern may be formed and film thickness loss may be improved and minimized during development.

Thus, the adhesive layer may have a glass transition temperature (Tg) of about 160 to 200° C. and a coefficient of thermal expansion (CTE) of 400 ppm/° C. or less, or about 200 to 400 ppm/° C., measured at a temperature of 50 to 200° C. Also, after the thermal curing, the adhesive layer may have a 5% or less weight loss when cured at a temperature of about 230 to 300° C.

According to an exemplary embodiment, a method of manufacturing a semiconductor package may include (a) applying the adhesive composition or disposing the above-described adhesive film onto a surface of a semiconductor chip or substrate; (b) forming a predetermined pattern in the applied adhesive composition or adhesive film by UV exposure using a photomask and development of the pattern; and (c) forming an adhesive layer by thermal curing.

In the step (a), the adhesive composition may be applied by a coating technique used in lithography, such as for example, by dipping, spin coating, or roll coating. Also, the applied amount may be appropriately selected to obtain a layer having a thickness of about 0.1 to about 100 μm. In some cases, the step (a) may be followed by volatilizing a solvent contained in the adhesive composition to remove the solvent. For example, the volatilization of the solvent may be performed at a temperature of about 30 to 150° C. for one minute to 2 hours.

In the step (b), the exposure may be performed using UV light through a photomask at a dose of about 10 to about 2,000 mJ/cm². As used herein, UV light includes light having a wavelength of less than about 450 nm. For example, UV light useful for lithography includes light having a wavelength of 436 nm (corresponding to the g-line of a mercury vapor lamp), 365 nm (corresponding to the i-line of a mercury vapor lamp), 248 nm (corresponding to the emission line of a KrF excimer laser), 193 nm (corresponding to the emission line of an ArF excimer laser), broadband emission of a mercury vapor lamp, or the like. After the UV exposure, heating to increase development sensitivity may be further performed if necessary.

The exposure or heating process may be followed by development with a developing agent. In this case, the developing agent may be a common developing agent used in photoresist development. The developing agent may be any organic solvent developing agent useful in the art, such as for example, dimethylacetamide, cyclohexanone, propylene glycol monomethylether acetate, 2-heptanone, ethyl lactate, amyl acetate, anisole, N-methylpyrrolidinone, and the like, and any combination comprising at least one of the foregoing. Alternatively, the developing agent may be an alkali developing agent, for example, an alkali aqueous solution containing at least one selected from the group consisting of alkali metal salts, such as sodium hydroxide, potassium hydroxide, sodium carbonate, sodium silicate, or sodium metasilicate; ammonia; alkyl amines, such as ethylamine, n-propyl amine, diethyl amine, di-n-propyl amine, triethylamine, or methyl diethyl amine; alkanol amines, such as dimethyl ethanol amine or triethanol amine; heterocyclic amines, such as pyrrole or piperidine; tetraalkyl ammonium hydroxides, such as tetramethyl ammonium hydroxide, tetraethyl ammonium hydroxide, or tetrabutylammonium hydroxide; and alkali compounds, such as choline, 1,8-diazabicyclo[5.4.0]-7-undecene (“DBU”) and 1,5-diazabicyclo[4.3.0]-5-nonene (“DBN”). Also, an aqueous solution obtained by adding an appropriate amount of an aqueous organic solvent, such as methanol or ethanol, or surfactant to the alkali aqueous solution may be used as the developing agent.

The developing time may in general be from about 30 to 360 seconds, according to the kind, mixture ratio, and layer thickness of each component in the adhesive composition, although not limited to these times which may depend on the composition being developed. Development methods may include a puddle development method, a dipping method, a paddle method, a spray method, or a shower development method. After the development, washing may be performed for, for example, about 30 to about 90 seconds, and then drying may be performed with hot air using an air arm, or using a hot plate or oven. Drying, it will be understood, should be carried out at a temperature less than that which might cause the developed features to flow. After development, further washing and drying may be performed as necessary.

In the step (c), thermal curing may be performed at a temperature of about 120 to about 300° C. for about 10 minutes to about 10 hours. With thermal curing, cross-linking density may increase, and any remaining volatile components may be removed so that the close adhesion of the adhesion composition or adhesion film to the base material may also increase and the thermal resistance and strength of the adhesion composition or adhesion film may be improved.

The steps (a) and (b) may be repeated according to the number of the semiconductor chips included in the semiconductor package, followed by a single step (c). The step (c) may be performed after each step (a) and/or (b) and/or (c), or may be performed once after step (c).

Furthermore, when the semiconductor chips are adhered to each other according to a method of manufacturing a semiconductor package, the semiconductor chip may be mounted on the patterned adhesive layer between the steps (b) and (c).

Hereinafter, the exemplary embodiments will be described in further detail with reference to Preparation Examples, Examples, Comparative Examples and Experimental Examples. The following examples are merely to explain the exemplary embodiments, not to limit the exemplary embodiments.

### SYNTHESIS EXAMPLE 1

### Synthesis of Silicon-Modified Polyimide (PI-1)

### SYNTHESIS EXAMPLE 1-1

3.66 g (10 mmol) of 2,2-bis(3-amino-4-hydroxyphenyl)-1,1,1,3,3,3-hexafluoropropane, and N-methyl pyrrolidone (NMP) as a solvent are added to a 250-ml flask provided with a stirrer, a thermometer, a nitrogen replacement apparatus, and a Dean-Stark trap. 4.44 g (10 mmol) of 4,4-(1,1,1,3,3,3-hexafluoro-isopropylidene)diphthalic anhydride is slowly dropped in the flask, and the mixture is stirred for about 10 hours. Next, 5 g of toluene is added to the mixture. The resulting solution is heated to a temperature of about 150° C., and further stirred for about 6 hours. Then, 0.35 _{g} of water is recovered using the Dean-Stark trap. After heating, the resulting solution is cooled to a room temperature to obtain a solution containing a polyimide resin represented by the formula of compound I (see Reaction Formula 2). The solution containing the polyimide resin is dropped into distilled water and then precipitated, and the remaining solvent is removed from the resulting solution. The resulting solution is vacuum-filtered and dried at about 80° C. for about 24 hours to obtain polyimide powder of compound I.

### SYNTHESIS EXAMPLE 1-2

10 g (12.8 mmol) polyimide powder of compound I prepared in Synthesis Example 1-1 is dissolved in 40 ml of cyclohexane. 2.78 g (17.9 mmol) 2-methacryloyloxyethyl isocyanate, 1.19 g (7.7 mmol) 3-(triethoxysilyl)propyl isocyanate, and 0.4 g (0.6 mmol) of dibutyltin dilaurate (“DBTDL”) as a urethane group reaction catalyst are added to the mixture to prepare silicon-modified polyimide PI-I by inducing a urethane reaction of a hydroxyl group of the polyimide with isocyanates of compounds II and III (see Reaction Formula 2) in a molar ratio of 7:3 for 12 hours.

### SYNTHESIS EXAMPLE 2

Silicon-modified polyimide PI-IA is prepared by the same method as described in Synthesis Example 1, except that 1.98 g (12.8 mmol) of 2-methacryloyloxyethyl isocyanate and 3.17 g (12.8 mmol) of 3-(triethoxysilyl)propylisocyanate are used to induce a urethane reaction of a hydroxyl group of the polyimide with isocyanates of compounds II and III (see Reaction Formula 2) in a molar ratio of 5:5 in Synthesis Example 1-2.

### SYNTHESIS EXAMPLE 3

Silicon-modified polyimide PI-1B is prepared by the same method as described in Synthesis Example 1, except that 1.19 g (7.7 mmol) of 2-methacryloyloxyethyl isocyanate and 4.43 g (17.9 mmol) of 3-(triethoxysilyl)propyl isocyanate are used to induce a urethane reaction of a hydroxyl group of the polyimide with isocyanates of compounds II and III (see Reaction Formula 2) in a molar ratio of 3:7 in Synthesis Example 1-2.

### SYNTHESIS EXAMPLE 4

Silicon-modified polyimide P1-1C is prepared by the same method as described in Synthesis Example 1, except that 6.33 g (25.6 mmol) of 3-(triethoxysilyl)propyl isocyanate is used to induce a urethane reaction of a hydroxyl group of the polyimide with isocyanates of compounds II and III (see Reaction Formula 2) in a molar ratio of 0:10 in Synthesis Example 1-2.

### SYNTHESIS EXAMPLE 5

Silicon-modified polyimide PI-2 is prepared by the same method as described in Synthesis Example 1, except that 3.22 g (10 mmol) of 3,3′,4,4′-benzophenone tetracarboxylic dianhydride is used instead of 4.44 g (10 mmol) of 4,4-(1,1,1,3,3,3-hexafluoro isopropylidene)diphthalic anhydride in Synthesis Example 1.

### SYNTHESIS EXAMPLE 6

Silicon-modified polyimide PI-3 is prepared by the same method as described in Synthesis Example 1, except that 3.10 g (10 mmol) of 4,4′-oxydiphthalic anhydride is used instead of 4.44 g (10 mmol) of 4,4-(1,1,1,3,3,3-hexafluoro isopropylidene)diphthalic anhydride in Synthesis Example 1.

### SYNTHESIS EXAMPLE 7

Silicon-modified polyimide PI-4 is prepared by the same method as described in Synthesis Example I, except that 2.94 g (10 mmol) of 3,3′,4,4′-biphenyl tetracarboxylic acid dianhydride is used instead of 4.44 g (10 mmol) of 4,4-(1,1,1,3,3,3-hexafluoro isopropylidene)diphthalic anhydride in Synthesis Example 1.

### SYNTHESIS EXAMPLE 8

Silicon-modified polyimide P1-5 is prepared by the same method as described in Synthesis Example 1, except that 2.18 g (10 mmol) of pyromellitic dianhydride (PMDA) is used instead of 4.44 g (10 mmol) of 4,4-(1,1,1,3,3,3-hexafluoro isopropylidene)diphthalic anhydride in Synthesis Example 1.

### SYNTHESIS EXAMPLE 9

### Synthesis of Silicon-Modified Polyimide PI-6 having Carboxylic Group Synthesis Example 9-1

3.29 g (9 mmol) of 2,2-bis(3-amino-4-hydroxyphenyl)-1,1,1,3,3,3-hexafluoropropane, 0.15 g (1 mmol) of 3,5-diamino benzoic acid, and N-methyl pyrrolidone (NMP) as a solvent are added to a 250-ml flask provided with a stirrer, a thermometer, a nitrogen replacement apparatus, and a Dean-Stark trap. 4.44 g (10 mmol) of 4,4-(1,1,1,3,3,3-hexafluoroisopropylidene)diphthalic anhydride is dropped in the flask, and the mixture is stirred for about 10 hours. Next, 5 g of toluene is added to the mixture. The resulting solution is heated to a temperature of about 150° C. and further stirred for about 6 hours. Then, 0.35 g of water is recovered using the Dean-Stark trap. After heating, the solution is cooled to room temperature to obtain a solution containing a polyimide (PI-2) resin. The solution containing the polyimide resin is dropped into distilled water and then precipitated, and the remaining solvent is removed from the resulting solution. The resulting solution is vacuum-filtered and dried at about 80° C. for about 24 hours to obtain the polyimide powder.

### SYNTHESIS EXAMPLE 9-2

10 g (13.1 mmol) of the polyimide powder prepared in Synthesis Example 5-1 is dissolved in 40 ml of cyclohexane. 2.56 g (16.5 mmol) of 2-methacryloyloxyethyl isocyanate, 1.76 g (7.1 mmol) of triethoxysilyl isocyanate, and 0.4 g (0.6 mmol) of dibutyltin dilaurate (DBTDL) as a urethane reaction catalyst are added to the mixture to prepare the silicon-modified polyimide PI-9 by inducing a urethane reaction of a hydroxyl group of polyimide with isocyanates of compounds II and III (see Reaction Formula 2, above) in a molar ratio of 7:3 for 12 hours.

### SYNTHESIS EXAMPLE 10

Silicon-modified polyimide PI-9A is prepared by the same method as described in Synthesis Example 9, except that 2.93g (8 mmol) of 2,2-bis(3-amino-4-hydroxyphenyl)-1,1,1,3,3,3-hexafluoropropane and 0.3g (2 mmol) of 3,5-diamino benzoic acid are used as diamine monomers in Synthesis Example 9-1.

### SYNTHESIS EXAMPLE 11

Silicon-modified polyimide PI-9B is prepared by the same method as described in Synthesis Example 9, except that 2.56 g (7 mmol) of 2,2-bis(3-amino-4-hydroxyphenyl)-1,1,1,3,3,3-hexafluoropropane and 0.46 g (3 mmol) of 3,5-diamino benzoic acid are used as diamine monomers in Synthesis Example 9-1.

### SYNTHESIS EXAMPLE 12

Silicon-modified polyimide PI-9C is prepared by the same method as described in Synthesis Example 9, except that 1.83 g (5 mmol) of 2,2-bis(3-amino-4-hydroxyphenyl)-1,1,1,3,3,3-hexafluoropropane and 0.76 g (5 mmol) of 3,5-diamino benzoic acid are used as diamine monomers in Synthesis Example 9-1.

### SYNTHESIS EXAMPLE 13

Silicon-modified polyimide PI-9D is prepared by the same method as described in Synthesis Example 9, except that 1.82 g (11.8 mmol) of 2-methacryloyloxyethyl isocyanate and 2.92 g (11.8 mmol) of triethoxysilyl isocyanate are used to induce a urethane reaction of a hydroxyl group of the polyimide with isocyanates of compounds II and III (see Reaction Formula 2, above) in a molar ratio of 5:5 in Synthesis Example 9-2.

### SYNTHESIS EXAMPLE 14

Silicon-modified polyimide PI-9E is prepared by the same method as described in Synthesis Example 9, except that 1.10 g (7.1 mmol) of 2-methacryloyloxyethyl isocyanate and 4.08 g (16.5 mmol) of triethoxysilyl isocyanate are used to induce a urethane reaction of a hydroxyl group of the polyimide with isocyanates of compounds II and III (see Reaction Formula 2, above) in a molar ratio of 3:7 in Synthesis Example 9-2.

### SYNTHESIS EXAMPLE 15

Silicon-modified polyimide PI-9F is prepared by the same method as described in Synthesis Example 9, except that 5.84 g (23.6 mmol) of triethoxysilyl isocyanate is used to induce a urethane reaction of a hydroxyl group of the polyimide with isocyanates of compounds II and III (see Reaction Formula 2, above) in a molar ratio of 0:10 in Synthesis Example 9-2.

### SYNTHESIS EXAMPLE 16

Silicon-modified polyimide PI-9G is prepared by the same method as described in Synthesis Example 9, except that 0.82 g (7.1 mmol) of 3-(trimethoxysilyl)propyl isocyanate is used as a silicon-modified group instead of 3-(triethoxysilyl)propyl isocyanate in Synthesis Example 9-2.

### EXAMPLE 1

5 parts by weight of silicon-modified polyimide prepared in Synthesis Example 1, 20 parts by weight of acryl binder (ACA-230AA; Daicel Chemicals), 30 parts by weight of multifunctional acrylate for patterning (ZFR-1401H; Nippon Kayaku), 15 parts by weight of UX-5002D (Nippon Kayaku), 1.5 parts by weight of 1-hydroxy-cyclohexyl-phenyl-ketone as a photopolymerization initiator (IRGACURE® 184; Ciba Specialty Chemicals), 1.5 parts by weight of α,α-dimethoxy-α-phenylacetophenone (IRGACURE® 651; Ciba Specialty Chemicals), 10 parts by weight of o-cresol novolac-based EOCN-104S (Nippon Kayaku) as a thermosetting resin, 10 parts by weight of YDCN-500-90P (Kukdo Chemicals), 4 parts by weight of a phenol-based curing agent (HF-1M; Meiwa Plastic), 0.1 parts by weight of 2-ethyl-4-methyl imidazole as a thermal-curing catalyst, (2E4MZ; Shikoku Chemicals), and 1.5 parts by weight of triarylsulfonium hexafluorophosphate salt as a photoacid generator are uniformly mixed in cyclohexanone to prepare a film-forming solution.

The solution is applied by casting using a casting knife onto to a polyethylene terephthalate (PET) film which is surface-treated with releasing silicon, and dried in a forced convection oven at about 85° C. for 20 minutes, to prepare an adhesive film having a thickness of 30 μm for patterning.

### COMPARATIVE EXAMPLE 1 AND EXAMPLES 2 to 8

A series of adhesive films are prepared by the same method as that of Example 1, except that the materials and compositions as shown in Table 1 below are used.

TABLE 1

| | | Comparative | Example | Example | Example | Example | Example | Example | Example | Example |
|---|---|---|---|---|---|---|---|---|---|---|
| Component* | | Example 1 | 1 | 2 | 3 | 4 | 5 | 6 | 7 | 8 |
| Acryl resin | ACA-230AA | 30 | 20 | 20 | 20 | 20 | 20 | 20 | 20 | 20 |
| Photosensitive | Synthesis Example 1 | | 5 | | | | | | | |
| PI | Synthesis Example 2 | | | 5 | | | | | | |
| | Synthesis Example 3 | | | | 5 | | | | | |
| | Synthesis Example 4 | | | | | 5 | | | | |
| | Synthesis Example 9 | | | | | | 5 | | | |
| | Synthesis Example 13 | | | | | | | 5 | | |
| | Synthesis Example 14 | | | | | | | | 5 | |
| | Synthesis Example 15 | | | | | | | | | 5 |
| Acrylate | ZFR 1401H | 30 | 30 | 30 | 30 | 30 | 30 | 30 | 30 | 30 |
| | UX-5002D | 15 | 15 | 15 | 15 | 15 | 15 | 15 | 15 | 15 |
| Photo-initiator | IRGACURE ® 184 | 1.5 | 1.5 | 1.5 | 1.5 | 1.5 | 1.5 | 1.5 | 1.5 | 1.5 |
| | IRGACURE ® 651 | 1.5 | 1.5 | 1.5 | 1.5 | 1.5 | 1.5 | 1.5 | 1.5 | 1.5 |
| Thermal | EOCN-104S | 10 | 10 | 10 | 10 | 10 | 10 | 10 | 10 | 10 |
| curing unit | YDCN-500-90P | 10 | 10 | 10 | 10 | 10 | 10 | 10 | 10 | 10 |
| Phenol resin | HF-1M | 4 | 4 | 4 | 4 | 4 | 4 | 4 | 4 | 4 |
| Thermal | 2E4MZ | 0.1 | 0.1 | 0.1 | 0.1 | 0.1 | 0.1 | 0.1 | 0.1 | 0.1 |
| curing catalyst | | | | | | | | | | |
| Photoacid | TASHFP** | 1.5 | 1.5 | 1.5 | 1.5 | 1.5 | 1.5 | 1.5 | 1.5 | 1.5 |
| generator | | | | | | | | | | |

*All component amounts are in parts by weight (pbw).
**TASHFP: Triarylsulfonium hexafluorophosphate salt

### EXPERIMENTAL EXAMPLE 1

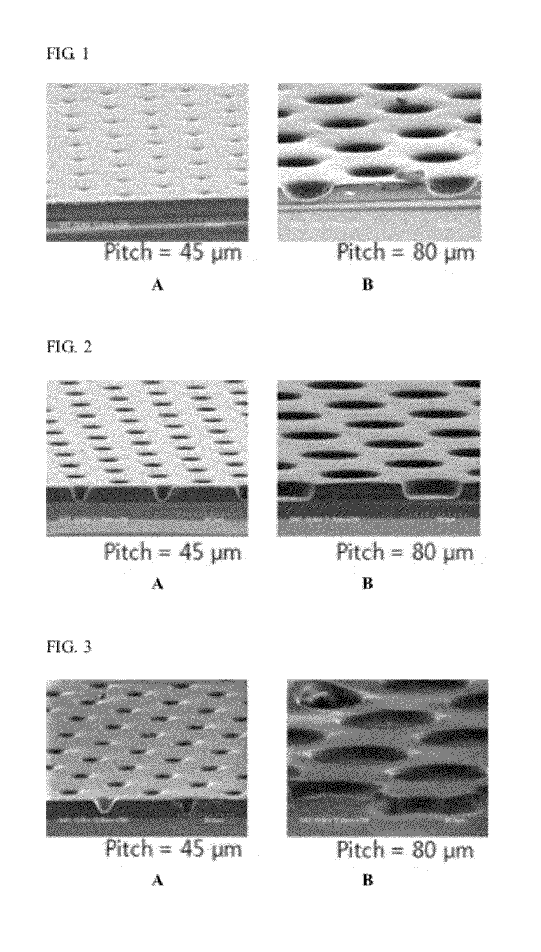

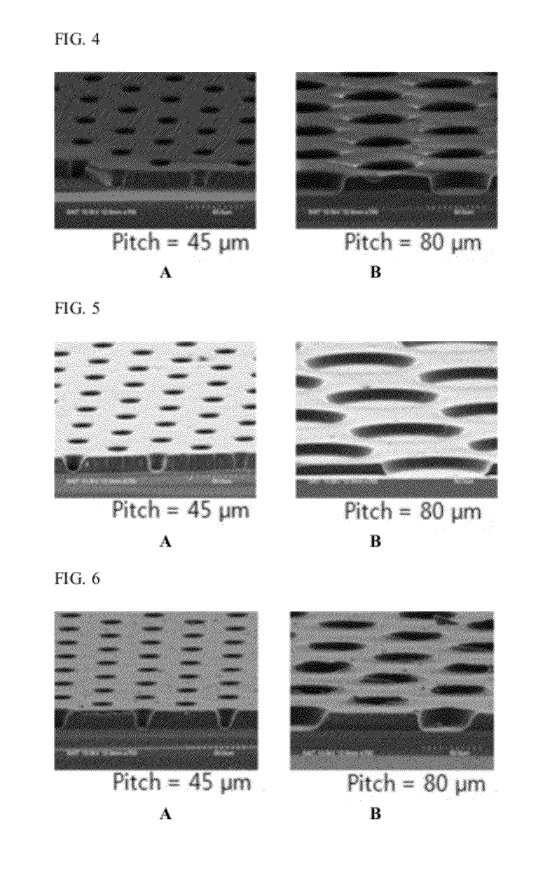

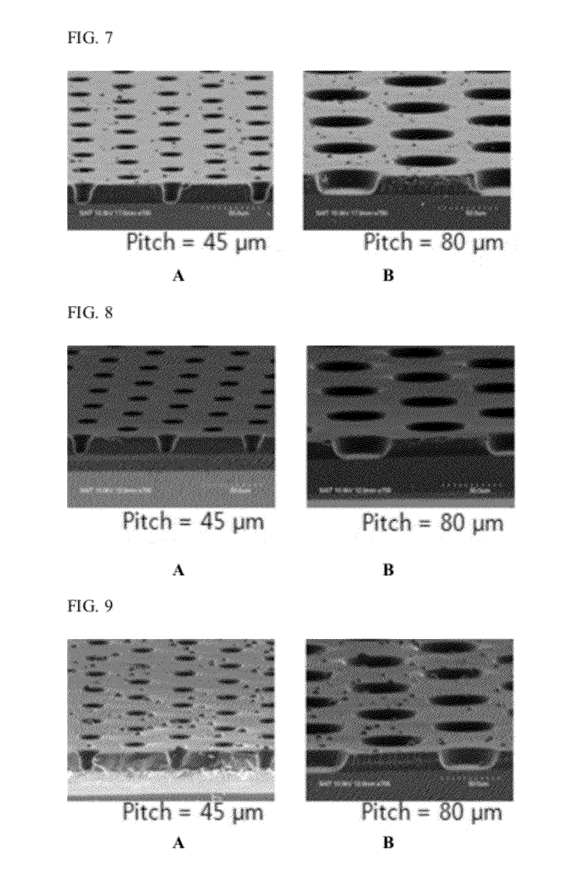

The patternability, thermal resistance, and adhesion strength of adhesion films including silicon modified polyimide are evaluated by the methods shown below, and the evaluation result are shown in Table 2. Also, scanning electron microscope (SEM) images of patterns are shown in FIGS. 1 to 9, each of which shows contact hole patterns having A) a 45 μm pitch, and B) an 80 μm pitch.

Patternability

An adhesive film is laminated to a 5×5-mm silicon wafer by pressurizing it with a roller at about 75° C. After light exposure with a high-precision parallel apparatus (USHIO, HB-25103BY-C) at an exposure dose of 1,000 mJ/cm², a post exposure-bake is performed at about 85° C. for 15 minutes. Next, the adhesive films according to Comparative Example 1 and Examples 1 to 8 are developed with a propylene glycol monomethylether acetate solution using a spin coater at a spin speed of 1,500 rpm for 30 seconds, and then washed with isopropyl alcohol at a spin speed of 1,000 rpm for 15 seconds to observe patterns. The adhesive films according to Comparative Example 2 and Examples 8 to 10 are developed with a 2.38% (by weight) tetramethylammonium hydroxide aqueous solution using a spin coater at a spin speed of 1,500 rpm for 30 seconds, and washed with ultrapure water (<18 milliohms per centimeter) at a rate of 1,000 rpm for 15 seconds to observe patterns.

When a pattern is precisely formed according to expected dimensions based on exposure conditions (mask/feature size, sidewall angle, and pitch), the result is designated as A. When a pattern is incompletely or insufficiently formed, the result is designated as B. And, when a pattern is not formed, the result is designated as C.

Die-Shear Strength

The wafer, which has a thickness of 530 μm, is cut to a size of about 5×5 mm, and then laminated with the adhesive film by pressurizing at about 75° C. as described above. The wafer is cut out together with the adhesive film to leave only laminated portions. The pre-UV-curing samples are applied to a lower chip which is cut to a size of 10×10 mm, on a hot plate at about 100° C. under 1 kgf pressure, and then cured at about 175° C. for 2 hours. The die-shear intensity of an upper chip is measured at about 250° C. at a rate of 100 μm/sec. The post-UV-curing samples are irradiated under the condition of light exposure, about 1,000 mJ/cm² with a high-precision parallel apparatus. Next, a patterning process is simulated under the same developing and cleaning conditions as these of the above, and then die-shear intensity is measured in the same method as that of the pre-UV-curing samples.

TABLE 2

| | Comparative | | | | | | | | |
|---|---|---|---|---|---|---|---|---|---|
| | Example 1 | Example 1 | Example 2 | Example 3 | Example 4 | Example 5 | Example 6 | Example 7 | Example 8 |
| Patternability | C | A | A | A | A | A | A | B | B |
| Die shear strength (Kgf/chip) | 8.2 | 15.6 | 14.0 | 14.6 | 16.6 | 15.2 | 16.5 | 14.3 | 16.6 |

As shown Table 2, it is seen that the adhesive films according to the Examples 1 to 8 have excellent patternability and die-shear intensity, when compared with that of Comparative Example 1.

The invention described hereinabove should not be construed as being limited to the embodiments set forth herein. Rather, these embodiments are provided so that this disclosure will be thorough and complete and will fully convey the concept of the present invention to those of ordinary skill in the art.

While the invention has been particularly shown and described with reference to embodiments thereof, it will be understood by those of ordinary skill in the art that various changes in form and details may be made therein without departing from the spirit or scope of the present invention as defined by the following claims.

What is claimed is:

1. A photosensitive polyimide, comprising:
an aromatic polyimide backbone,
a first side chain including a (meth)acryloyl group grafted to the aromatic polyimide backbone, and
a second side chain including ,a silicon-modified group grafted to the aromatic polyimide backbone.

2. The photosensitive polyimide according to claim 1, wherein the aromatic polyimide backbone comprises a repeating unit A selected from the group consisting of Formula 1-1, Formula 1-2, and Formula 1-3, and any combination thereof: 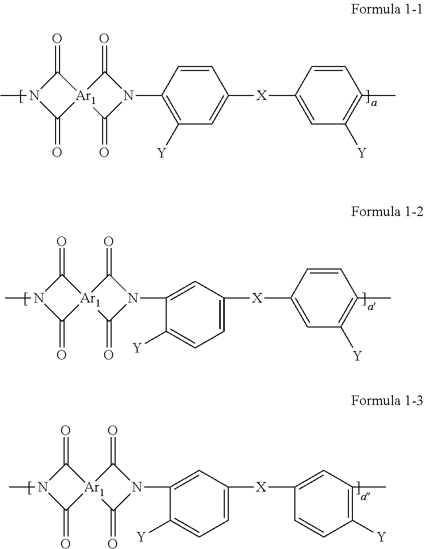
wherein Ar₁ is a quaternary organic group;
X is selected from the group consisting of: 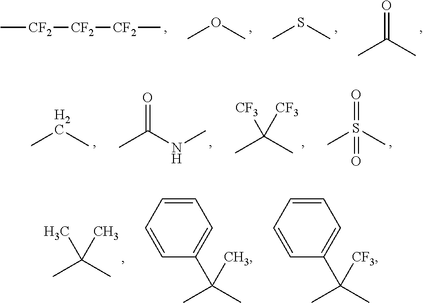
and any combination thereof;
Y is selected from the group consisting of —O—, —NH—, —S—, and any combination thereof, and a, a′, and a″ are each independently an integer of 1 or more.

3. The photosensitive polyimide according to claim 1, wherein the aromatic polyimide backbone comprises the imidization product of a tetracarboxylic acid dianhydride represented by Formula 2: 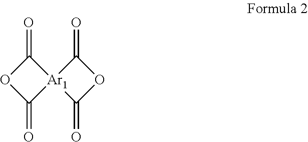
wherein Ar₁ is a quaternary organic group; and
a diamine selected from the group consisting of Formulae 1-1a, 1-2a, and 1-3a, and any combination thereof: 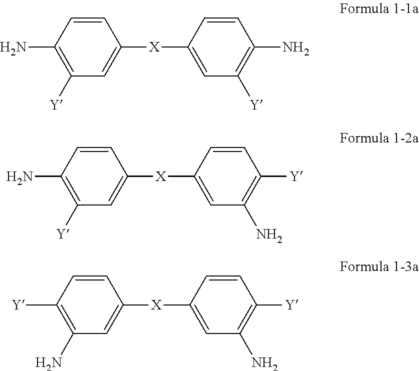
wherein, in Formulae 1-1a, 1-2a, and 1-3a, X is selected from the group consisting of: 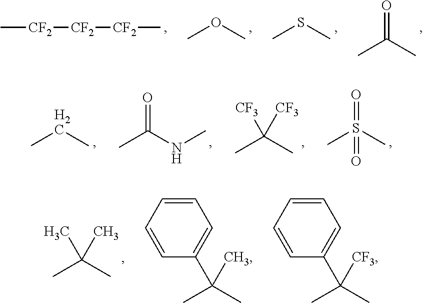
and any combination thereof; and
Y′ is selected from the group consisting of: —OH, —NH₂, —SH, and any combination thereof.

4. The photosensitive polyimide according to claim 2, wherein the aromatic polyimide backbone further includes a repeating unit B, which is the reaction product of a tetracarboxylic acid dianhydride represented by Formula 2 with a diamine,
wherein the diamine is selected from the group consisting of substituted or unsubstituted aromatic diamine, aliphatic ether diamine, diamino siloxane, and any combination thereof, and wherein when the diamine is substituted, a substituent is selected from the group consisting of hydrogen, an alkyl group having 1 to 20 carbon atoms, a hydroxyl group, a carboxyl group, an aromatic hydroxyl group, and any combination thereof: 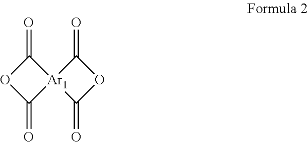
where Ar₁ is a quaternary organic group.

5. The photosensitive polyimide according to claim 4, wherein the repeating unit B is selected from the group consisting of Formula 2-1, Formula 2-2, and any combination thereof: 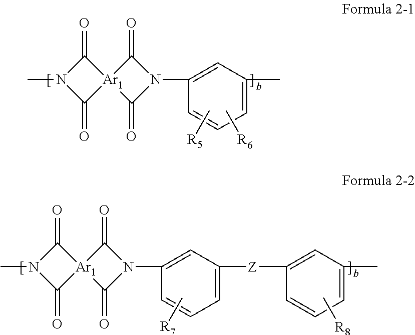
where Ar₁ is a quaternary organic group; Z is selected from the group consisting of 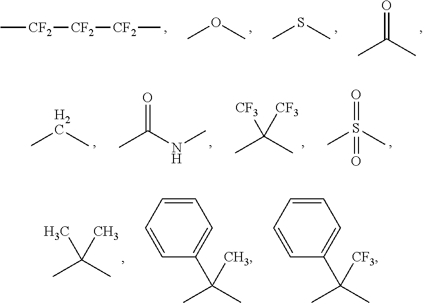
and any
combination thereof;
R₅, R₆, R₇, and R₈ are independently selected from the group consisting of hydrogen, an alkyl group having 1 to 20 carbon atoms, a hydroxyl group, a carboxyl group, an aromatic hydroxyl group, and any combination thereof, and each b is independently an integer of one or more.

6. The photosensitive polyimide according to claim 2, wherein Ar₁ is selected from the group consisting of: 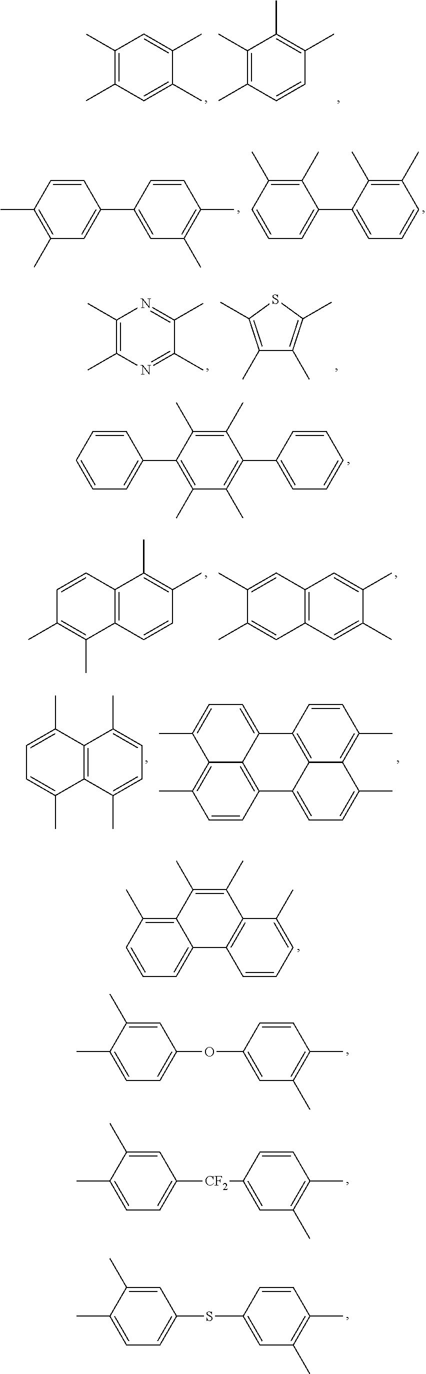 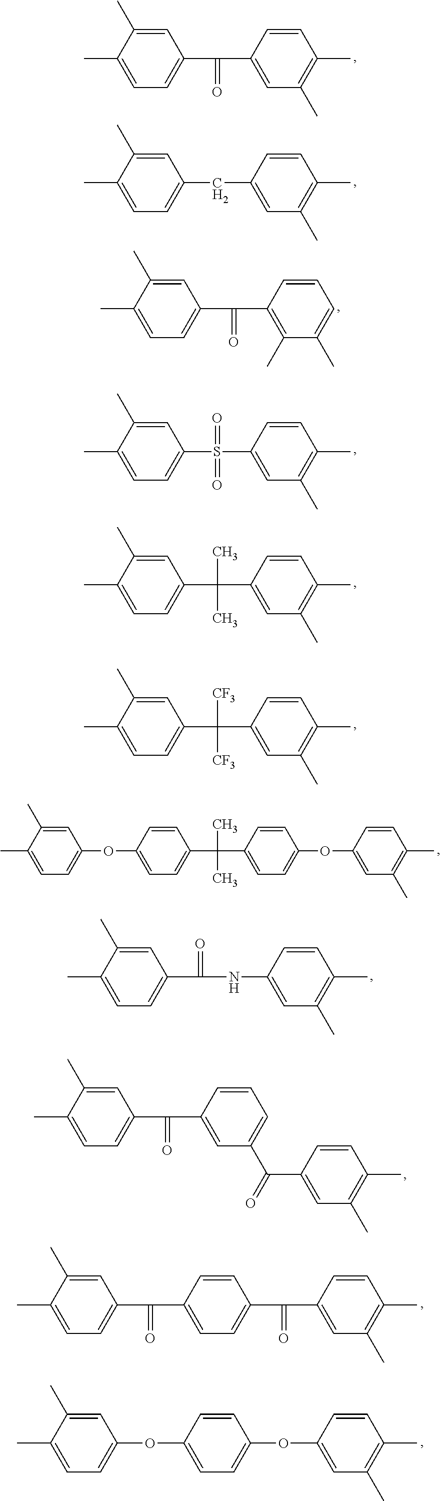
and any combination thereof.

7. The photosensitive polyimide according to claim 4, wherein, in the aromatic polyimide backbone, when the molar ratios of the repeating units A and B are respectively a and b, 0.30≦a/(a+b)≦0.98 and 0.02≦b/(a+b)≦0.70, and a+b is 1.

8. The photosensitive polyimide according to claim 2, wherein the first side chain including the (meth)acryloyl group and the second side chain including the silicon-modified group are each grafted onto the same repeating unit A, or onto different repeating units A.

9. The photosensitive polyimide according to claim 8, wherein the side chain containing the (meth)acryloyl group includes the (meth)acryloyl group and an amide group.

10. The photosensitive polyimide according to claim 9, wherein the side chain including the (meth)acryloyl group is represented by Formula 3: 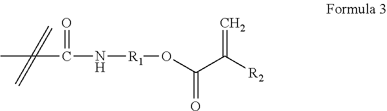
where R₁ is selected from the group consisting of alkylene having 1 to 10 carbon atoms, —Rₐ—OR_{b}—, —Rₐ—C(═O)OR_{b}—, —Rₐ—OC(═O)R_{b}—, and any combination thereof, Rₐ and R_{b} may be independently alkylene having 1 to 6 carbon atoms, R₁ further includes a substituent selected from the group consisting of hydrogen, alkyl having 1 to 10 carbon atoms, —R′—OR″, —R′—C(═O)OR″, —R′—OC(═O)R″, —R′—OC(═O)C(═CH₂)R″, and any combination thereof, R′ is independently alkylene having 1 to 6 carbon atoms, and R″ is independently hydrogen or alkyl having 1 to 6 carbon atoms; and
R₂ is hydrogen or methyl.

11. The photosensitive polyimide according to claim 10, wherein the side chain represented by Formula 3 is represented by Formula 3-1 or Formula 3-2: 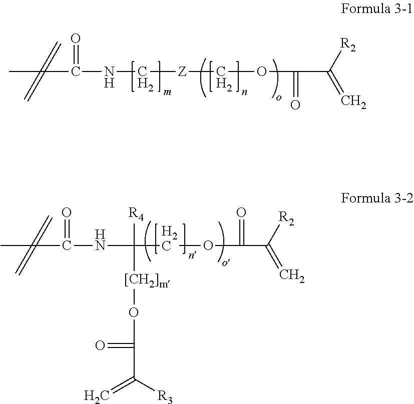
wherein Z is selected from the group consisting of a direct bond, —O—, —C(═O)O—, and —OC(═O)—;
m and m′ are independently an integer of 1 to 6;
n and n′ are independently an integer of 0 to 5, and o and o′ are independently an integer of 0 to 10, except that when Z is —O—, —C(═O)O—, or —OC(═O)—, n and o are not 0;
R₂ and R₃ are independently hydrogen or methyl; and
R₄ is hydrogen or alkyl having 1 to 6 carbon atoms.

12. The photosensitive polyimide according to claim 11, wherein the side chain represented by Formula 3-1 or 3-2 is any one represented by one of Formula 3-3 to Formula 3-5:

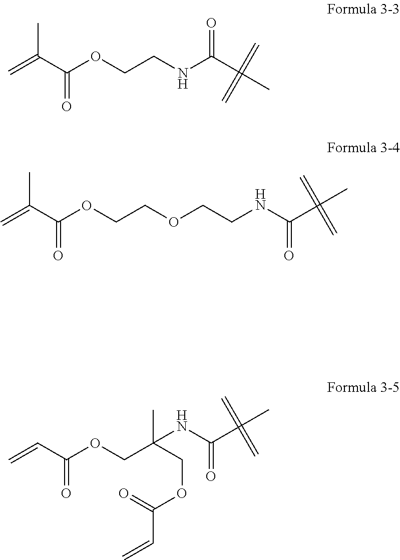

13. The photosensitive polyimide according to claim 1, wherein the second side chain including the silicon-modified group is represented by Formula 4: 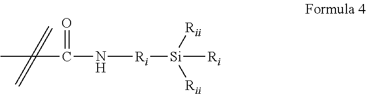
wherein Rᵢ is selected from the group consisting of alkyl having 1 to 10 carbon atoms, —Rₐ—OR_{b}—, —Rₐ—C(═O)OR_{b}—, —Rₐ—OC(═O)R_{b}—, and any combination thereof. Rₐ and R_{b} may be independently alkylene having 1 to 6 carbon atoms, Ri further includes a substituent selected from the group consisting of hydrogen, alkyl having 1 to 10 carbon atoms, —R′—OR″, —R′—C(═O)OR″, and —R′—OC(═O)R″, and any combination thereof, R′ is independently alkylene having 1 to 6 carbon atoms, and R″ are independently hydrogen or alkyl having 1 to 6 carbon atoms; and
Rᵢᵢ is selected from the group consisting of hydrogen, alkyl having 1 to 10 carbon atoms, alkoxy having 1 to 10 carbon atoms, and any combination thereof.

14. The photosensitive polyimide according to claim 13, wherein the second side chain is formed by introducing at least one compound selected from the group consisting of 3-(triethoxysilyl)propyl isocyanate, 3-(trimethoxysilyl)propyl isocyanate, and tetraethoxysilane.

15. The photosensitive polyimide according to claim 1, which contains the first side chain and the second side chain in a molar ratio of about 1:9 to about 9:1.

16. An adhesive composition comprising the photosensitive polyimide according to claim 1.

17. The adhesive composition according to claim 16, further comprising at least one selected from the group consisting of an organic solvent, a photocurable acrylate-based compound, a binder, a thermal curing agent, a photo-initiator, a photoacid generator, and any combination thereof.

18. The adhesive composition according to claim 17, comprising about 5 to about 40 parts by weight of the photosensitive polyimide, about 10 to about 30 parts by weight of the photocurable acrylate-based compound, about 5 to about 40 parts by weight of the binder, about 10 to about 50 parts by weight of the thermal curing agent, about 0.1 to about 10 parts by weight of the photo-initiator, and about 0.1 to about 10 parts by weight of the photoacid generator.

19. A semiconductor package, comprising:
a plurality of semiconductor chips; and
an adhesive layer formed by curing the adhesive composition according to claim 16.

20. The semiconductor package according to claim 19, wherein the adhesive layer includes a photosensitive acrylate resin and a photosensitive aromatic polyimide-based resin having a (meth)acrylate side chain group and a silicon-modified side chain group, and has a structure obtained by crosslinking the photosensitive polyimide-based resin and the photosensitive acrylate resin by the (meth)acrylate side chain group.
